(19) United States
(12) Patent Application Publication
(10) Pub. No.: US 2005/0088369 A1
(43) Pub. Date: Apr. 28, 2005

(54) Plasma display panel and its driving method

(76) Inventor: Toshihiro Yoshioka, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/491,722

(22) PCT Filed: Oct. 3, 2002
(86) PCT No.: PCT/JP02/10336

(30) Foreign Application Priority Data
Oct. 4, 2001 (JP) 2001-308272

(51) Int. Cl. G09G 3/28

(52) U.S. Cl. 345/60

(57) ABSTRACT

A plasma display panel and its driving method are provided, which is capable of improving high speed performance and reducing the necessary voltage for a selective discharge for switching a discharge cell and preferably of suppressing a brightness in a black display and making it easy to modulate the minimum brightness for improving the quality of image.

A scanning pulse voltage and a high-level data pulse voltage are so set that even if a data pulse of a discharge cell is low level or this discharge cell is non-selected, then in this non-selected discharge cell, a weak discharge 501 is generated between a low resistive wiring 111b and a stepped portion 203 over a data electrode 210 which are overlapped each other, and if a data pulse of a discharge cell is high level or this discharge cell is selected, then the weak discharge 501 is generated immediately after application of the data pulse before this discharge expends to a position under a transparent electrode 111a, whereby the weak discharge 501 becomes a discharge 502.

### TECHNICAL FIELD

The present invention relates to a plasma display panel, and more particularly to a plasma display panel having an improvement in a quality of image, wherein the plasma display panel is used as a large-size plat panel display for a high definition television and a wall-mounted television, as well as for displays of a personal computer and a workstation.

### BACKGROUND OF THE ART

An AC-luminescence plasma display panel of three-electrode surface-discharge type has the following configuration. The term “up-and-bottom directions” means directions, along which electrodes are formed with reference to a glass substrate. FIG. 1A is a fragmentary plan view showing arrangements of electrodes of a conventional plasma display panel. FIG. 1B is a fragmentary cross sectional elevation view, taken along a B-B line of FIG. 1A, showing a cross sectional structure of the conventional plasma display panel.

The conventional plasma display panel comprises a front substrate 1, a back substrate 2 and a discharge space 3 defined between them.

The front substrate 1 includes a first glass substrate 101 and surface discharge electrodes 110. The surface discharge electrodes 110 further includes a plurality of scanning electrode 111 and a plurality of common electrode 112, both of which extend in a first horizontal direction over the first glass substrate 101. The scanning electrode 111 further includes a transparent electrode 111a and a low-resistive interconnection 111b laminated over the transparent electrode 111a. The common electrode 112 further includes a transparent electrode 112a and a low-resistive interconnection 112b laminated over the transparent electrode 112a. A dielectric layer 103 is formed over the first glass substrate 101, wherein the dielectric layer 103 covers the surface discharge electrode 110. A protection film 104 is formed over the dielectric layer 103. The low resistive layers 111b and 112b are provided to reduce line resistances of the scanning electrode 111 and the sustaining electrode 112.

The back substrate 2 includes a second glass substrate 201 and a plurality of data electrode 210. The second glass substrate 201 is arranged to face to the first glass substrate 101. The plurality of data electrode 210 extend over the second glass substrate 201 and in a direction perpendicular to the above-described surface discharge electrode 110. A dielectric layer 205 is formed over the second glass substrate 201, wherein the dielectric layer 205 covers the plurality of data electrode 210. Separating walls 220 are formed over the dielectric layer 205, wherein the separating walls 220 extend in a second direction perpendicular to the above-described first direction for separating adjacent discharge cells from each other in the above-described first direction. In the discharge cell, a fluorescent layer 202 is formed on side feces of the separating walls 220 and over the dielectric layer 205.

As a modified example, there are another conventional plasma display panel having such a structure that separating walls of #-shape are formed, which extend not only in the second direction but also in the first direction for separating two-dimensionally-adjacent discharge cells from each other.

The tops of the separating walls 220 are almost in contact with the front substrate 1. The front substrate 1 and the back substrate 2 are bonded to each other so that the surface discharge electrodes 110 extend in the direction perpendicular to the direction along which the plurality of data electrode 210 extend, whereby the discharge space 3 is defined between the front substrate 1 and the back substrate 2. This discharge space 3 is filled with a discharge gas.

This discharge gas has main components of He and Ne, and a further component of Xe with a partial pressure of not higher than 50 hPa, wherein a total pressure of the discharge gas is adjusted in the range of approximately 500-800 hPa. The discharge cells, each having a discharge space, are aligned in matrix to form a dot matrix display.

The fluorescent layers 202 are aligned so that a set of fluorescent colors of Red (R), Green (G) and Blue (B) is repeated in the horizontal direction as shown in FIG. 1B. A single pixel 300 comprises three discharge cells 30R, 30G and 30B which are provided with the above-described fluorescent layers of three primary colors, respectively. The scanning electrode 111 and the common electrode 112, which are respectively positioned at the a-th position from the top, are presented by Sa and Ca, respectively. The data electrodes, provided in the discharge cells 30R, 30G and 30B in the pixel 300 positioned at the b-th position from the left, are respectively presented DRb, DGb and DBb. FIG. 2 is a schematic plan view showing an arrangement of the electrodes of the conventional plasma display panel. As shown in FIG. 2, a set of the scanning electrodes S1 through Sn constitutes an electrode group 11. A set of the common electrodes C1 through Cn constitutes another electrode group 12. A set of the data electrodes D1 through Dn constitutes still another electrode group 21.

In the conventional plasma display panel with such configuration, an ultraviolet light is emitted through discharge process and then irradiated onto the fluorescent material 202 in the each discharge cell, whereby this ultraviolet light is converted into a visible light for displaying an image.

The conventional plasma display panel is driven as follows. A controlled voltage is applied to a pair of electrodes included in the discharge cell. If, for example, a voltage applied between the scanning electrode 111 and the data electrode 210 is greater than a reference value, then a discharge is caused. If the voltage applied between the scanning electrode 111 and the data electrode 210 is not greater than the reference value, then any discharge is not caused. A continuation of the discharge depends upon the presence or absence of this selective discharge, provided that a pulse voltage is subsequently applied between the scanning electrode 111 and the common electrode 112 in the discharge cell. A luminescent state or a non-luminescent state of the discharge cell can be controlled by controlling this selective discharge.

FIG. 3 is a schematic view showing a configuration of a single frame. FIG. 4 is a timing chart showing a typical example of method of driving the conventional plasma display panel.

In accordance with a sub-field method for a gray scale display, as shown in FIG. 3, the single frame includes a plurality of sub-fields SF1 through SFN, wherein each sub-field further includes, for example, a reset discharge time period 701, a priming discharge time period 702, a selective discharge time period 703 and a display discharge time period 710, If the discharge cell selected in the selective discharge time period 703 has luminescent intensities of 2n (n=0˜N−1), then this realizes gray scales of N-levels. A blank time period 709 may be provided at the end of the single frame for time adjustment. Alternatively, the blank time period may be provided between the sub-fields.

In a reset discharge time period 701 of the first sub-field SF1, a reset pulse Pr with a rectangle-shaped waveform is applied to the scanning electrodes S1 through Sn. Subsequently, in the priming discharge time period 702, a priming pulse Pp1 with a rectangle-shaped waveform is applied to the common electrodes C1 through Cn, while a priming deleting pulse Pp2 with a rectangle-shaped waveform is applied to the scanning electrodes S1 through Sn, for neutralization of charges on the surface discharge electrode after the discharge has been caused, whereby a priming discharge is caused for supplying priming particles. In the selective discharge time period 703, the scanning pulse Ps is applied sequentially to the scanning electrodes S1 through Sn, as well as a data pulse Pd corresponding to display data is also applied to the data electrode 210 in synchronizing with the scanning pulse Ps. As a result, the selective discharge is caused in the discharge cell applied at the same timing with the scanning pulse Ps and the data pulse Pd, whereby in the subsequent display discharge time period 710, the sustaining discharge pulse is applied to sustain the discharge, wherein this discharge cell remains in the selected state. No discharge is caused in the discharge cell which is not applied with the data pulse Pd. Even if the sustaining pulse is applied to this discharge cell, then no discharge is caused, wherein this discharge cell remains in the non-selected state. This selection or non-selection is made to all of the scanning lines as necessary for luminescence or non-luminescence of the display area.

FIG. 5 is a timing chart showing another method of driving the conventional plasma display panel. The following descriptions will be made of only the difference from the above-described conventional driving method of FIG. 4. In accordance with this method, a reset pulse Prp of a large rectangle waveform is applied to the scanning electrodes S1 through Sn in the reset discharge time period 701a in each of the sub-fields. A discharge is generated which neutralizing the wall charge on the surface discharge electrode at the falling edge of this reset pulse. Consequently, the reset discharge in this reset discharge time period 701a serves to supply the priming particles.

FIG. 6 is a timing chart showing still another method of driving the conventional plasma display panel. The following descriptions will be made of only the difference from the above-described conventional driving method of FIG. 4. In accordance with this method, a reset pulse Ps1 of a saw-tooth waveform is applied to the scanning electrodes S1 through Sn in the first reset discharge time period 701d in each of the sub-fields. Another reset pulse Ps2 of a saw-tooth waveform is applied to the common electrodes C1 through Cn in the second reset discharge time period 701c. In accordance with this reset discharge, any intensive discharge is not caused. This allows a suppression to any other luminescence than the display discharge.

It is also possible, in case, that the discharge for supplying the priming particles is caused but not for all of the sub-fields.

In accordance with the above-described driving method using the sub-fields, if all sub-fields are non-selected, then this frame has a black display. It is preferable that the brightness of the black display is so lower as possible. If only a sub-field of a minimum luminescent intensity is selected, then the brightness is the second lower to the black display. In order to obtain a smooth image display, it is preferable that this minimum brightness value is so smaller as possible, provided that the gray scale display can be realized.

In accordance with the conventional plasma display panel, a discharge initiation voltage level for selective discharge depends mainly upon an opposite discharge gap or a distance of the discharge space 3 between the first glass substrate 101 and the second glass substrate 201. As described above, if the opposite discharge gap is applied with a voltage exceeding the discharge initiation voltage level for selective discharge, then the selective discharge is caused, whereby this discharge cell is placed into the selected state. If the voltage not exceeding the discharge initiation voltage level is applied, then any selective discharge is not caused, whereby this discharge cell is placed into the non-selected state.

In accordance with the conventional plasma display panel, the discharge initiation voltage and generation area of the selective discharge are almost uniform over the entirety of the opposite discharge space, in which the selective discharge is defined by a pair of overlapped electrodes which cause the opposite discharge. FIG. 7A is a cross sectional view showing a discharge cell in a non-selected state in the conventional plasma display panel. As shown in FIG. 7A, if the discharge cell is in the non-selected state, then the selective discharge is not caused. FIG. 7B is a cross sectional view showing a discharge cell in an initial selected state in the conventional plasma display panel. As shown in FIG. 7B, in the initial selected state, a weak discharge 511 is caused between the center of the scanning electrode 111 and the data electrode 210. FIG. 7C is a cross sectional view showing a discharge cell in a subsequent selected state in the conventional plasma display panel. As shown in FIG. 7C, in the subsequent selected state, a discharge 512 is expended to the entirety of the opposite discharge space between the scanning electrode 111 and the data electrode 210. The weak discharge 511 and the subsequent intensive discharge 512 caused in the selected discharge time period are generated in the same area and the same time as the discharge generated in the subsequent display discharge time period.

Japanese laid-open patent publication No. 2001-142430 describes a method of controlling the driving voltage so that a weak discharge similar to the above-described discharge 511 is caused by the scanning voltage applied to the non-selected cell free of any application of the data voltage.

In accordance with the above-described conventional plasma display, it is necessary that ions or excited atoms (hereinafter referred to as “priming particles”) have already been present over the entirety of the discharge space prior to the selective discharge, wherein the priming particles are capable of supplying initial electrons directly or indirectly through the secondary electron emission effect for initiating the discharge. For this reason, a discharge (hereinafter referred to as “priming discharge”) is caused for making the priming particles present over the area, in which the selective discharge is generated. This priming discharge increases the brightness of the black display.

For causing no priming discharge and quickly generating a selective discharge with a sufficient intensity in the absence of a large amount of the priming particles, it is necessary to apply an excess voltage which is much higher than the discharge initiation voltage. It is also necessary to increase the voltage of the data pulse for increasing the difference of the applied voltages form each other for distinguishing the selected and non-selected states. This requires the increase in the current of the selective discharge, resulting in increases in the cost of the driving circuit and the power comsumption.

In accordance with the conventional driving method, the minimum brightness of the selected discharge cell can be obtained but only when only the discharge is caused but no display discharge is caused. As described above, however, the excess voltage much higher than the discharge initiation voltage is applied for causing the selective discharge in the conventional plasma display. The selective discharge is caused over the entirety of the opposite discharge space, for which reason it is difficult to control the luminescent intensity and the minimum brightness of the selective discharge.

In case of applying the scanning voltage without application of data voltage, for causing a weak discharge with a constant low intensity at crossing area between the data electrode and the scanning electrode, it is not only necessary to suppress extremely small the variation of the opposite discharge voltage over the entirety of the panel, but also necessary to increase a pulse width of the scanning voltage for causing a weak discharge because of an insufficient excess voltage. This makes it necessary to take a longer time of the selective discharge. Further, the luminescence cased directly by this weak discharge and a visible luminescence indirectly caused through the fluorescence excited by the weak discharge are observed as the black brightness. This means a deterioration of the luminescent performance.

In connection with the discharge gas including any of Xe, Kr, Ar and N2, if the sum of the partial pressures of those components is not higher than 50 hPa, a relatively weak voltage as applied can generate the selective discharge with a lower luminescent efficiency and a difficulty to improve the luminescent performance of the panel. Particularly, if the partial pressures of those components are relatively high, then this causes increased delay of discharge and increased discharge voltage, resulting in an increased data voltage necessary to write operation.

### DISCLOSURE OF THE INVENTION

Accordingly, it is an object of the present invention to provide a novel plasma display panel free of the above-described problems.

It is a further object of the present invention to provide a novel plasma display panel capable of quick selective discharge at a reduced voltage for switching discharge cells.

It is a further more object of the present invention to provide a novel plasma display panel capable of suppressing the brightness of the black display.

It is a still further object of the present invention to provide a novel plasma display panel capable of easy modulation to the minimum brightness.

It is yet a further object of the present invention to provide a novel plasma display panel improved in the image quality.

It is moreover object of the present invention to provide a novel driving method for a plasma display panel free of the above-described problems.

It is still more object of the present invention to provide a novel driving method for a plasma display panel capable of quick selective discharge at a reduced voltage for switching discharge cells.

It is yet more object of the present invention to provide a novel driving method for a plasma display panel capable of suppressing the brightness of the black display.

It is another object of the present invention to provide a novel driving method for a plasma display panel capable of easy modulation to the minimum brightness.

It is still another object of the present invention to provide a novel driving method for a plasma display panel improved in the image quality.

A first plasma display panel in accordance with the present invention includes first and second substrates arranged facing to each other; a plurality of first electrodes provided on a surface of the first substrate, facing to the second substrate, and the plurality of first electrodes extending in a first direction; a plurality of second electrodes provided on a surface of the second substrate, facing to the first substrate, and the plurality of second electrodes extending in a second direction perpendicular to the first direction; a control circuit for controlling voltages applied to the first and second electrodes, based on an image signal; and discharge cells arranged at crossing points of the plurality of first electrodes and the plurality of second electrodes, and the discharge cells generating an ultraviolet light, which is irradiated to fluorescence layers provided in the discharge cells and then are converted into visible lights for image display, wherein the control circuit controls the voltages applied to the first and second electrodes so that, with scanning the first electrodes, a local discharge is generated between the first and second electrodes in a discharge cell to be selected based on the image signal, then an expansion of the local discharge is caused in the discharge cell, and subsequently a continuation of the expanded discharge is caused in only a discharge cell having the expanded discharge but after scanning the first electrodes.

A second plasma display panel in accordance with the present invention includes: first and second substrates arranged facing to each other; a plurality of first electrodes provided on a surface of the first substrate, facing to the second substrate, and the plurality of first electrodes extending in a first direction; a plurality of second electrodes provided on a surface of the second substrate, facing to the first substrate, and the plurality of second electrodes extending in a second direction perpendicular to the first direction; a control circuit for controlling voltages applied to the first and second electrodes, based on an image signal; and discharge cells arranged at crossing points of the plurality of first electrodes and the plurality of second electrodes, and the discharge cells generating an ultraviolet light, which is irradiated to fluorescence layers provided in the discharge cells and then are converted into visible lights for image display, wherein the control circuit controls the voltages applied to the first and second electrodes so that, with scanning the first electrodes, a local discharge is generated between the first and second electrodes in a discharge cell to be selected based on the image signal as well as a non-selected cell, then an expansion of the local discharge is caused in the discharge cell only, and subsequently a continuation of the expanded discharge is caused in only the discharge cell having the expanded discharge but after scanning the first electrodes.

In those plasma display panels, in a selective discharge, a locally generated discharge serves as a priming discharge. This allows a short time selective voltage pulse to realize a high speed write operation and reduce the necessary voltage. There is unnecessary any priming discharge expanding over an entirety of the discharge cell one or plural times in a single frame as a discharge display cycle. This reduces the luminescent brightness in the black display, and also simplifies the driving circuit. Namely, the priming particles are supplied just before respective write discharges. This makes it unnecessary to cause any intensive priming discharge which expends over the entirty of the discharge cell by taking into account the reduction of the priming particles during the selective discharge time period. This allows a high quality display and a power voltage reduction as well as an improved high speed performance and a simplified driving circuit.

Such local discharge can be generated by causing a distribution of charges (wall charges) prior to the selective discharge time period or by such a cell structure that a stronger electric field is caused at a part of the discharge cell in an initial time period of the selective discharge for reducing a discharge initiation voltage at this part as compared to the other parts of the discharge cell.

A light-shielding layer such as a black matrix may be provided for shielding a visible light from being transmitted to the outside, wherein the visible light has been converted from the discharge locally generated. The light-shielding layer further reduces the luminescent brightness of the black display.

The light-shielding part may have a black-color-band layer which extends over at least adjacent discharge cells in the second direction.

The first electrode may have a main electrode part and a sub-electrode part arranged closer to an edge of the discharge cell than the main electrode part, and in this case, the control circuit controls the voltages so that the local discharge is caused between the sub-electrode part and the second electrode for controlling the expansion of the local discharge in the non-selected discharge cell.

The first and second substrates may have a distance at least at a position of one edge of the discharge cell in the second direction, wherein the distance is smaller than a distance between the first and second substrates at a center position of the discharge cell. The control circuit controls the voltages so that the local discharge is caused at the position of one edge, and then the expansion of the local discharge to the center position is caused.

The discharge space between the first and second substrates may be filled with a discharge gas containing at least one component selected from the group consisting of Xe, Kr, Ar and N2, and a total sum of partial pressures of Xe, Kr, Ar and N2 in the discharge gas is not lower than 100 hPa. This makes it easy to control the generation era of the local discharge into a limited narrow area.

The first electrode may have a scanning electrode and a common electrode which are separated from each other within the single discharge cell, and the control circuit provides a potential difference between the scanning electrode and the common electrode for causing a continuation of the discharge after scanning the first electrodes. The scanning electrode may have a main scanning electrode part and a sub-scanning electrode part arranged closer to an edge of the discharge cell than the main scanning electrode part, and the control circuit controls the voltages so that the local discharge is caused between the sub-scanning electrode part and the second electrode.

A transparent dielectric layer may be provided, which covering the first electrode, wherein the first electrode has a scanning electrode and a common electrode which are separated from each other within the single discharge cell, and the dielectric layer has a smaller thickness, in a discharge gap region between the scanning electrode and the common electrode, than other part of the dielectric layer. This suppresses any similar discharge to the selected local discharge from being generated in the display discharge.

A third plasma display panel in accordance with the present invention includes first and second substrates arranged facing to each other; a plurality of first electrodes provided on a surface of the first substrate, facing to the second substrate, and the plurality of first electrodes extending in a first direction; a plurality of second electrodes provided on a surface of the second substrate, facing to the first substrate, and the plurality of second electrodes extending in a second direction perpendicular to the first direction; a control circuit for controlling voltages applied to the first and second electrodes, based on an image signal; and discharge cells arranged at crossing points of the plurality of first electrodes and the plurality of second electrodes, and the discharge cells generating ultraviolet lights, which are irradiated to fluorescence layers provided in the discharge cells and then are converted into visible lights for image display, wherein the control circuit controls the voltages applied to the first and second electrodes so that, with scanning the first electrodes, a local discharge is generated between the first and second electrodes in a discharge cell to be selected based on the image signal, then an expansion of the local discharge is caused in the discharge cell.

A fourth plasma display panel in accordance with the present invention includes first and second substrates arranged facing to each other; a plurality of first electrodes provided on a surface of the first substrate, facing to the second substrate, and the plurality of first electrodes extending in a first direction; a plurality of second electrodes provided on a surface of the second substrate, facing to the first substrate, and the plurality of second electrodes extending in a second direction perpendicular to the first direction; a control circuit for controlling voltages applied to the first and second electrodes, based on an image signal; and discharge cells arranged at crossing points of the plurality of first electrodes and the plurality of second electrodes, and the discharge cells generating ultraviolet lights, which are irradiated to fluorescence layers provided in the discharge cells and then are converted into visible lights for image display, wherein the control circuit controls the voltages applied to the first and second electrodes so that, with scanning the first electrodes, a local discharge is generated between the first and second electrodes in a discharge cell to be selected based on the image signal, then an expansion of the local discharge is caused in the discharge cell, and subsequently a continuation of the expanded discharge is caused in only a discharge cell having the expanded discharge but after scanning the first electrodes.

In those plasma display panels, luminescent intensities according to a distribution in amount of the wall charges accumulated by the write discharge can be obtained by the discharge in the display discharge time period. This makes it possible that the brightness is modulated at the same pulse voltage, for a gray scale with lower brightness levels.

The luminescent intensities of selective discharges of the discharge cells may correspond to a minimum brightness except for a black display. The luminescent intensifies of selective discharges of the discharge cells may take plural values depending upon voltages applied in selection, and the control circuit selects the voltages for modulation to luminescent brightness.

A fifth plasma display panel in accordance with the present invention includes: first and second substrates arranged facing to each other; a plurality of first electrodes provided on a surface of the first substrate, facing to the second substrate, and the plurality of first electrodes extending in a first direction; a plurality of second electrodes provided on a surface of the second substrate, facing to the first substrate, and the plurality of second electrodes extending in a second direction perpendicular to the first direction; and discharge cells arranged at crossing points of the plurality of first electrodes and the plurality of second electrodes, and the discharge cells generating ultraviolet lights, which are irradiated to fluorescence layers provided in the discharge cells and then are converted into visible lights for image display, wherein the first electrode has a main electrode part and a sub-electrode part arranged closer to an edge of the discharge cell than the main electrode part.

The main electrode part may comprise at least one kind selected from the group consisting of line-shaped electrodes containing a transparent conductive material and metal, and the sub-electrode part comprises a material lower in electrical resistance than the transparent conductive material, for example, a metal-based low-resistive wiring material for suppressing the resistance of the electrode.

A sixth plasma display panel in accordance with the present invention includes: first and second substrates arranged facing to each other; a plurality of first electrodes provided on a surface of the first substrate, facing to the second substrate, and the plurality of first electrodes extending in a first direction; a plurality of second electrodes provided on a surface of the second substrate, facing to the first substrate, and the plurality of second electrodes extending in a second direction perpendicular to the first direction; and discharge cells arranged at crossing points of the plurality of first electrodes and the plurality of second electrodes, and the discharge cells generating lights, which are irradiated to fluorescence layers provided in the discharge cells and then are converted into visible lights for image display, wherein a stepped portion is provided over the second substrate, and the stepped portion is positioned at an edge of the discharge cell with reference to a direction, in which the second electrode extends, and a height of a discharge space at a center of the discharge cell with reference to the direction, in which the second electrode extends is higher than a height of the discharge space at the edge.

A height of the stepped portion may preferably be in the range from 0.2 times to 0.9 times of a height of the discharge space at the center, and more preferably in the range from 0.6 times to 0.9 times of the height of the discharge space at the center. The adjustment to the height of the stepped portion makes it easy that an area of a low opposite discharge voltage is localized in the vicinity of the stepped portion. Upper surfaces of the stepped portion may be planarized, and a width of the planarized part with reference to a direction, along which the second electrode extends, may preferably be in the range of 0.2 times to 0.7 times of a length of the discharge cell in the direction, and more preferably in the range of 0.5 times to 0.7 times of the length of the discharge cell in the direction. This adjustment to the width of the planarized part of the stepped portion makes it easy to maintain a practically useful luminescent brightness and localizing an area of a low opposite discharge voltage in the vicinity of the stepped portion.

It is also preferable that a width of a discharge space at a center of the discharge cell with reference to a direction, along which the second electrode extends, is wider than a width of the discharge space over the stepped portion. A light-shielding layer may be provided over the first substrate, and the light-shielding layer extending along a boundary between discharge cells adjacent to each other with reference to a direction, in which the second electrode extends, and the light-shielding layer extending in parallel to the first electrode. The light-shielding layer is narrower than a width of a planarized part of supper surfaces of the stepped portion, with reference to a direction, along which the second electrode extends. This makes it easy to maintain a practically useful luminescent brightness and suppress unnecessary visible light from being transmitted from the inside of the discharge cell to the display screen.

A seventh plasma display panel in accordance with the present invention includes discharge cells filled with a discharge gas containing at least one component selected from the group consisting of Xe, Kr, and Ar, and a total sum of partial pressures of Xe, Kr, and Ar is not lower than 100 hPa.

The discharge gas may further contain N2, and a total sum of partial pressures of Xe, Kr, Ar and N2 is not lower than 100 hPa.

The plasma display panel may further include: first and second substrates arranged facing to each other; a plurality of first electrodes provided on a surface of the first substrate, facing to the second substrate, and the plurality of first electrodes extending in a first direction; a plurality of second electrodes provided on a surface of the second substrate, facing to the first substrate, and the plurality of second electrodes extending in a second direction perpendicular to the first direction; and discharge cells arranged at crossing points of the plurality of first electrodes and the plurality of second electrodes, and the discharge cells generating lights, which are irradiated to fluorescence layers provided in the discharge cells and then are converted into visible lights for image display. The first electrode may have a main electrode part and a sub-electrode part arranged closer to an edge of the discharge cell than the main electrode part. A stepped portion may be provided over the second substrate, and the stepped portion may be positioned at an edge of the discharge cell with reference to a direction, in which the second electrode extends, and a height of a discharge space at a center of the discharge cell with reference to the direction, in which the second electrode extends may be higher than a height of the discharge space at the edge. A light-shielding layer may be provided over the first substrate, wherein the light-shielding layer extends along a boundary between discharge cells adjacent to each other with reference to a direction, in which the second electrode extends, and the light-shielding layer extends in parallel to the first electrode. If the first electrode has the main electrode part and the sub-electrode part, then this improves the luminescent efficiency and shortens a selected time period at a low voltage. The formation of the stepped portion forms an area with a lower opposite discharge voltage in the discharge cell, and also makes it possible to shorten a selected time period at a low voltage. The provision of the light-shielding layer makes it possible to maintain a practically useful luminescent brightness and suppress unnecessary visible light from being transmitted from the inside of the discharge cell to the display screen, thereby obtaining a high contrast.

A first method of driving a plasma display panel including: first and second substrates arranged facing to each other; a plurality of first electrodes provided on a surface of the first substrate, facing to the second substrate, and the plurality of first electrodes extending in a first direction; a plurality of second electrodes provided on a surface of the second substrate, facing to the first substrate, and the plurality of second electrodes extending in a second direction perpendicular to the first direction; and discharge cells arranged at crossing points of the plurality of first electrodes and the plurality of second electrodes, and the discharge cells generating ultraviolet lights, which are irradiated to fluorescence layers provided in the discharge cells and then are converted into visible lights for image display, wherein the method includes the steps of: sequentially applying a scanning voltage to a selected electrode of the first electrodes for generating a selective discharge between the selected electrode and the second electrode, and also generating a local discharge between the first and second electrodes in a discharge cell to be selected based on an image signal for subsequent expansion of the local discharge in the discharge cell; and subsequently continuing the expanded discharge in only the discharge cell having the expanded discharge.

A second method of driving a plasma display panel including first and second substrates arranged facing to each other; a plurality of first electrodes provided on a surface of the first substrate, facing to the second substrate, and the plurality of first electrodes extending in a first direction; a plurality of second electrodes provided on a surface of the second substrate, facing to the first substrate, and the plurality of second electrodes extending in a second direction perpendicular to the first direction; and discharge cells arranged at crossing points of the plurality of first electrodes and the plurality of second electrodes, and the discharge cells generating ultraviolet lights, which are irradiated to fluorescence layers provided in the discharge cells and then are converted into visible lights for image display, wherein with scanning the first electrodes, a local discharge is generated between the first and second electrodes in a discharge cell to be selected based on the image signal, then an expansion of the local discharge is caused in the discharge cell.

### BRIEF DESCRIPTION OF THE DRAWING

FIG. 1A is a fragmentary plan view showing an arrangement of electrodes of the conventional plasma display panel.

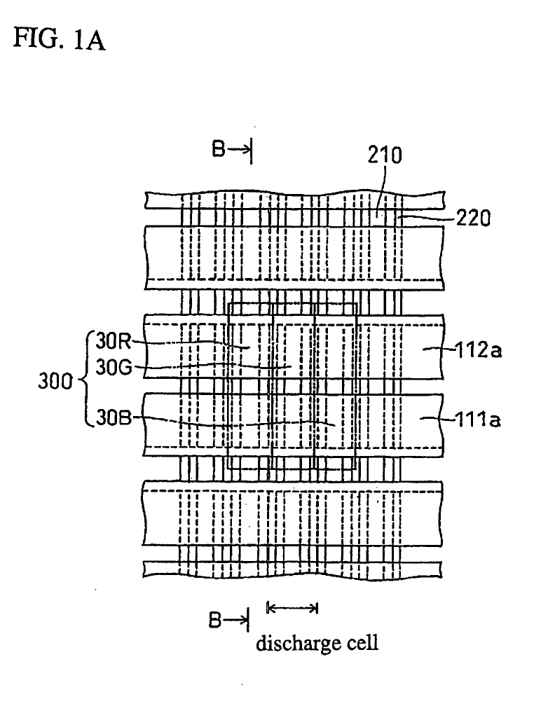

FIG. 1B is a fragmentary cross sectional view showing a sectioned structure of the conventional plasma display panel.

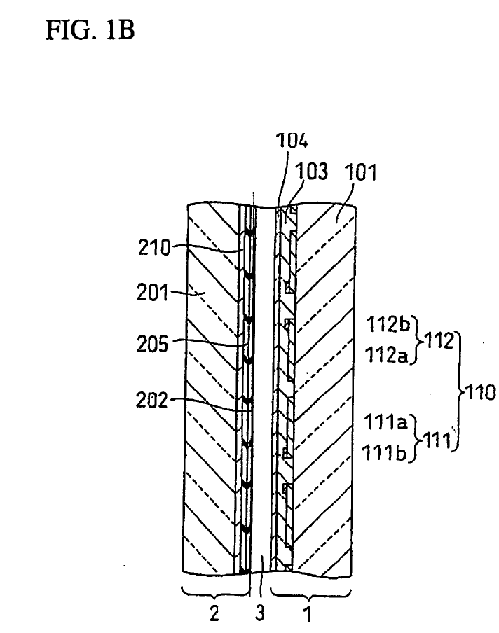

FIG. 2 is a schematic plan view showing an arrangement of electrodes of the conventional plasma display panel.

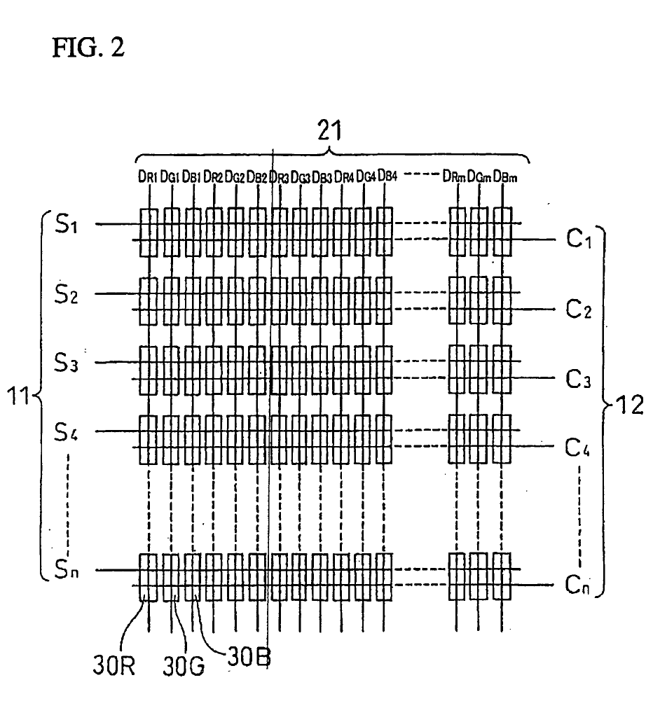

FIG. 3 is a schematic view showing a configuration of a single frame.

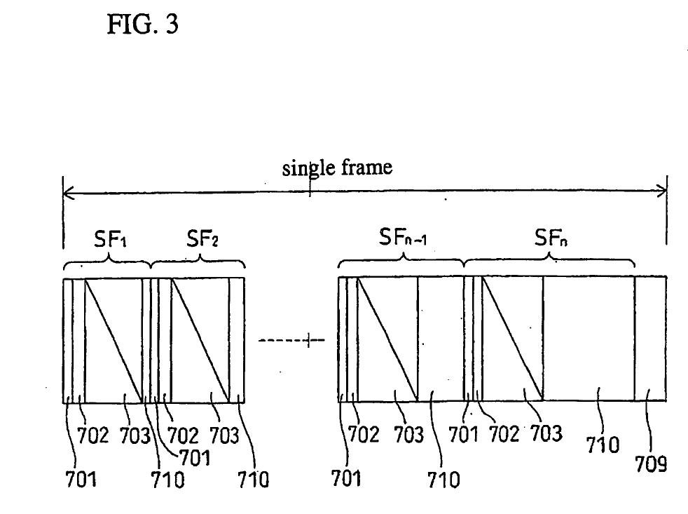

FIG. 4 is a timing chart showing a typical example of a method of driving the conventional plasma display panel.

FIG. 5 is a timing chart showing a typical example of another method of driving the conventional plasma display panel.

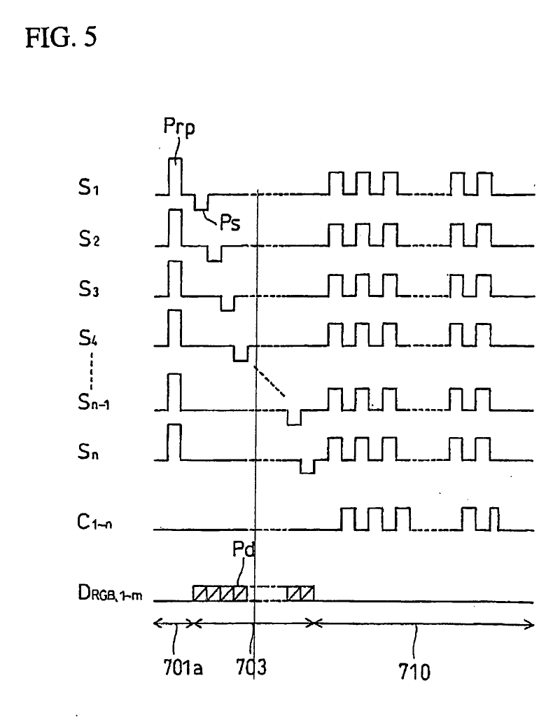

FIG. 6 is a timing chart showing a typical example of still another method of driving the conventional plasma display panel.

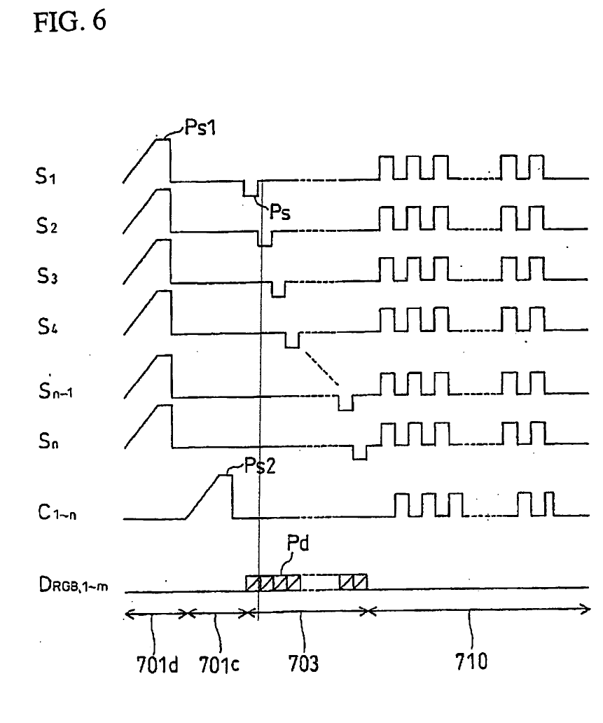

FIG. 7A is a sectional view showing a discharge cell in a non-selected state in the conventional plasma display panel.

FIG. 7B is a sectional view showing a discharge cell in an initial selected state in the conventional plasma display panel.

FIG. 7C is a sectional view showing a discharge cell in a subsequent selected state in the conventional plasma display panel.

FIG. 8A is a fragmentary plan view showing a configuration of a plasma display panel in accordance with the first embodiment of the present invention.

FIG. 8B is a fragmentary plan view showing a layout of electrodes in FIG. 8A.

FIG. 9 is a fragmentary cross sectional view taken along an A-A line in FIGS. 8A and 8B.

FIG. 10 is a timing chart showing a method of driving the plasma display panel in accordance with the first embodiment of the present invention.

FIG. 11A is a fragmentary cross sectional view showing a discharge cell in a non-discharge state of the plasma display panel in accordance with the first embodiment of the present invention.

FIG. 11B is a fragmentary cross sectional view showing a discharge cell in a weak initial discharge state of the plasma display panel in accordance with the first embodiment of the present invention.

FIG. 11C is a fragmentary cross sectional view showing a discharge cell in a transitional discharge state of the plasma display panel in accordance with the first embodiment of the present invention.

FIG. 11D is a fragmentary cross sectional view showing a discharge cell in a display discharge state of the plasma display panel in accordance with the first embodiment of the present invention.

FIG. 12 is a timing chart showing another method of driving the plasma display panel in accordance with the first embodiment of the present invention.

FIG. 13A is a fragmentary cross sectional view showing a discharge cell in a non-discharge state of the plasma display panel in accordance with the second embodiment of the present invention.

FIG. 13B is a fragmentary cross sectional view showing a discharge cell in a weak initial discharge state of the plasma display panel in accordance with the second embodiment of the present invention.

FIG. 13C is a fragmentary cross sectional view showing a discharge cell in a transitional discharge state of the plasma display panel in accordance with the second embodiment of the present invention.

FIG. 13D is a fragmentary cross sectional view showing a discharge cell in a display discharge state of the plasma display panel in accordance with the second embodiment of the present invention.

FIG. 14A is a fragmentary cross sectional view showing a discharge cell in a weak initial discharge state of the plasma display panel in accordance with the second embodiment of the present invention.

FIG. 14B is a fragmentary cross sectional view showing a discharge cell in a display discharge state of the plasma display panel in accordance with the second embodiment of the present invention.

FIG. 15A is a fragmentary plan view showing an example of a connection structure between a transparent electrode and a low resistive wiring.

FIG. 15B is a fragmentary plan view showing another example of a connection structure between a transparent electrode and a low resistive wiring.

FIG. 15C is a fragmentary plan view showing another example of a connection structure between a transparent electrode and a low resistive wiring.

FIG. 15D is a fragmentary plan view showing another example of a connection structure between a transparent electrode and a low resistive wiring.

FIG. 16 is a timing chart showing another method of driving the plasma display panel in accordance with the third embodiment of the present invention.

FIG. 17A is a cross sectional view showing a uniform distribution of wall charges of a discharge cell of the plasma display panel in accordance with the third embodiment of the present invention.

FIG. 17A is a cross sectional view showing a local distribution of wall charges of a discharge cell of the plasma display panel in accordance with the third embodiment of the present invention.

FIG. 18A is a fragmentary cross sectional view showing a discharge cell in a non-discharge state of the plasma display panel in accordance with the third embodiment of the present invention.

FIG. 18B is a fragmentary cross sectional view showing a discharge cell in a weak initial discharge state of the plasma display panel in accordance with the third embodiment of the present invention.

FIG. 18C is a fragmentary cross sectional view showing a discharge cell in a display discharge state of the plasma display panel in accordance with the third embodiment of the present invention.

FIG. 19 is a fragmentary plan view showing a modified example of a configuration of the plasma display panel in accordance with the third embodiment of the present invention.

FIG. 20 is a timing chart showing another method of driving the plasma display panel in accordance with the fourth embodiment of the present invention.

FIG. 21A is a fragmentary cross sectional view showing a discharge cell in a weak initial discharge state of the plasma display panel in accordance with the fourth embodiment of the present invention.

FIG. 21B is a fragmentary cross sectional view showing a discharge cell in a transitional discharge state of the plasma display panel in accordance with the fourth embodiment of the present invention.

FIG. 21C is a fragmentary cross sectional view showing a discharge cell in a display discharge state of the plasma display panel in accordance with the fourth embodiment of the present invention.

FIG. 22A is a fragmentary cross sectional view showing a discharge cell in a weak initial discharge state of the plasma display panel in accordance with the fifth embodiment of the present invention.

FIG. 22B is a fragmentary cross sectional view showing a discharge cell in a transitional discharge state of the plasma display panel in accordance with the fifth embodiment of the present invention.

FIG. 22C is a fragmentary cross sectional view showing a discharge cell in a display discharge state of the plasma display panel in accordance with the fifth embodiment of the present invention.

FIG. 23A is a fragmentary cross sectional view showing a discharge cell in a non-discharge state of the plasma display panel in accordance with the sixth embodiment of the present invention.

FIG. 23B is a fragmentary cross sectional view showing a discharge cell in a weak initial discharge state of the plasma display panel in accordance with the sixth embodiment of the present invention.

FIG. 23C is a fragmentary cross sectional view showing a discharge cell in a display discharge state of the plasma display panel in accordance with the sixth embodiment of the present invention.

FIG. 24 is a fragmentary plan view showing a configuration over a back substrate of a plasma display panel in accordance with the seventh embodiment of the present invention.

FIG. 25 is a fragmentary plan view showing a configuration over a back substrate of a plasma display panel in accordance with the eighth embodiment of the present invention.

FIG. 26 is a fragmentary plan view showing a configuration over a back substrate of a plasma display panel in accordance with the ninth embodiment of the present invention.

FIG. 27A is a fragmentary cross sectional view showing a discharge cell in a non-discharge state of the plasma display panel in accordance with the tenth embodiment of the present invention.

FIG. 27B is a fragmentary cross sectional view showing a discharge cell in a weak initial discharge state of the plasma display panel in accordance with the tenth embodiment of the present invention.

FIG. 27C is a fragmentary cross sectional view showing a discharge cell in a transitional discharge state of the plasma display panel in accordance with the tenth embodiment of the present invention.

FIG. 27D is a fragmentary cross sectional view showing a discharge cell in a display discharge state of the plasma display panel in accordance with the tenth embodiment of the present invention.

FIG. 28 is a timing chart showing a method of driving the plasma display panel in accordance with the tenth embodiment of the present invention.

FIG. 29A is a fragmentary cross sectional view showing a discharge cell in a non-discharge state of the plasma display panel in accordance with the eleventh embodiment of the present invention.

FIG. 29B is a fragmentary cross sectional view showing a discharge cell in a weak initial discharge state of the plasma display panel in accordance with the eleventh embodiment of the present invention.

FIG. 29C is a fragmentary cross sectional view showing a discharge cell in a transitional discharge state of the plasma display panel in accordance with the eleventh embodiment of the present invention.

FIG. 30 is a timing chart showing a method of driving the plasma display panel in accordance with the eleventh embodiment of the present invention.

FIG. 31 is a schematic view showing a configuration of a single frame in accordance with the twelfth embodiment of the present invention.

FIG. 32 is a timing chart showing a method of driving the plasma display panel in accordance with the twelfth embodiment of the present invention.

FIG. 33A is a cross sectional view showing a discharge cell in a transitional discharge state of the plasma display panel in accordance with the twelfth embodiment of the present invention.

FIG. 33B is a cross sectional view showing a discharge cell in a transitional discharge state of the plasma display panel in accordance with the twelfth embodiment of the present invention.

FIG. 34 is a view showing values of luminescent efficiencies under partial pressures of Xe, Kr and Ar.

### THE BEST MODE FOR CARRYING OUT THE INVENTION

A plasma display panel and a method of driving the same in accordance with the present invention will hereinafter be described in details with reference to the accompanying drawings.

### FIRST EMBODIMENT

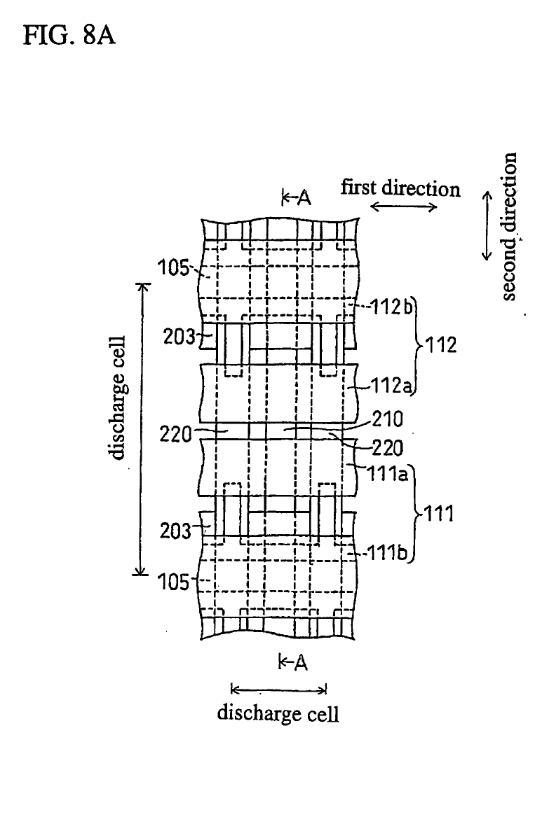

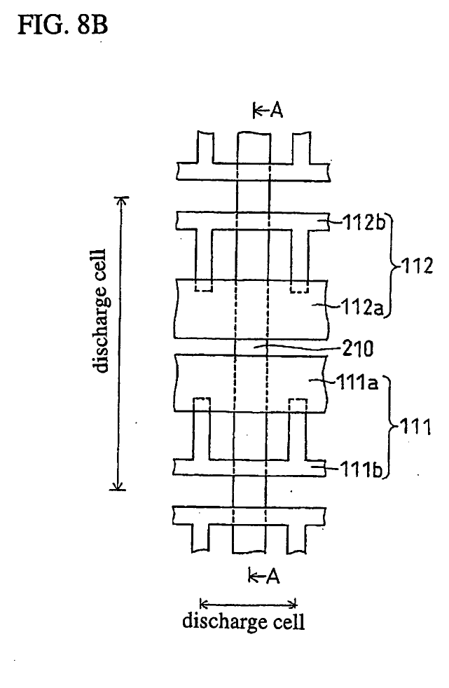

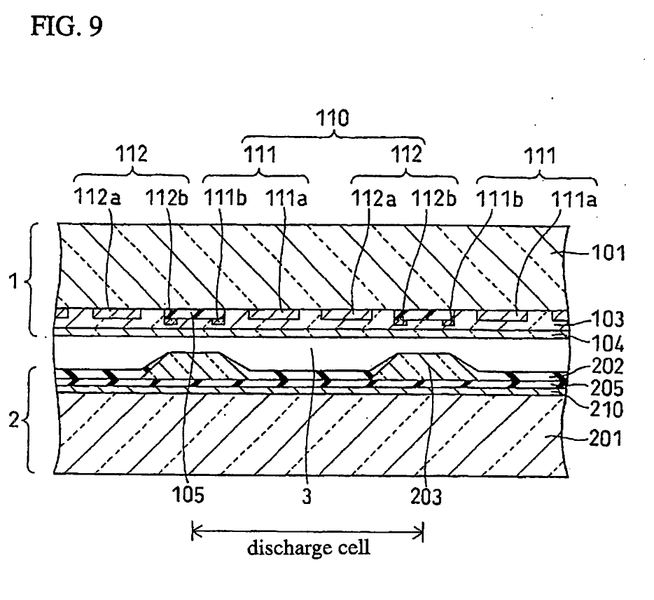

FIG. 8A is a fragmentary plan view showing a configuration of a plasma display panel in accordance with the first embodiment of the present invention. FIG. 8B is a fragmentary plan view showing a layout of electrodes in FIG. 8A. FIG. 9 is a fragmentary cross sectional view taken along an A-A line in FIGS. 8A and 8B.

In accordance with the first embodiment, the plasma display panel comprises a front substrate 1, a back substrate 2 and a discharge space defined between them. The front substrate 1 includes a first glass substrate 101, a plurality of surface discharge electrodes 110 and a plurality of light shielding layers 105. The surface discharge electrode 110 further includes a plurality of scanning electrodes 111 and a plurality of common electrodes 112, wherein the scanning electrodes 111 and the common electrodes 112 extend in a first horizontal direction and over the first glass substrate 101. The scanning electrode 111 further includes a transparent electrode 111a and a low resistive wiring 111b. The common electrode 112 further includes a transparent electrode 111a and a low resistive wiring 111b.

The above-described plurality of light shielding layers 105 extend in the first horizontal direction and over the first glass substrate 101. The plurality of light shielding layers 105 are arranged on boundaries of adjacent discharge cells in a second horizontal direction perpendicular to the first horizontal direction. The plurality of light shielding layers 105 shield externally reflected light and any unnecessary lights from the discharge spaces 3 of the respective discharge spaces.

A pair of the transparent electrode 111a of the scanning electrode and the transparent electrode 112a of the common electrode is provided between adjacent two light shielding layers 105. The transparent electrode 111a of the scanning electrode and the transparent electrode 112a of the common electrode are separated from each other and also are separated from the light shielding layers 105. Each of the transparent electrode 111a and the transparent electrode 112a may, for example, comprise a transparent conductive thin film of an indium oxide based material or a tin oxide based material.

The low resistive wiring 111b of the scanning electrode and the low resistive wiring 112b of the common electrode make a pair and extend in the first direction and over the respective light shielding layers 105. The low resistive wiring 111b of the scanning electrode and the low resistive wiring 112b of the common electrode are separated from each other. The edge of the low resistive wiring 111b of the scanning electrode is aligned to the first edge of the light shielding layer 105. The edge of the low resistive wiring 112b of the common electrode is aligned to the second edge of the light shielding layer 105. The first edge of the light shielding layer 105 is closer to the transparent electrode 111a of the scanning electrode. The second edge of the light shielding layer 105 is closer to the transparent electrode 112a of the common electrode. The first edge of the light shielding layer 105 is separated from the low resistive wiring 111b of the scanning electrode. The second edge of the light shielding layer 105 is separated from the low resistive wiring 112b of the common electrode. Each of the low resistive wiring 111b of the scanning electrode and the low resistive wiring 112b of the common electrode may comprise a metal thin film or a metal material including metal fine particles as a main component.

The transparent electrode 111a and the low resistive wiring 111b of the scanning electrode are connected to each other through a connection not illustrated at the boundary between the adjacent discharge cells in the first direction. The transparent electrode 112a and the low resistive wiring 112b of the common electrode are connected to each other through another connection not illustrated at the other boundary between the adjacent discharge cells in the first direction. In the discharge cell area except for those boundary areas, the transparent electrode 111a of the scanning electrode and the transparent electrode 112a of the common electrode are separated from each other as well as the low resistive wiring 111b of the scanning electrode and the low resistive wiring 112b of the common electrode are separated from each other. As described above, the scanning electrode 111 comprises the transparent electrode 111a and the low resistive wiring 111b. The common electrode 112 comprises the transparent electrode 112a and the low resistive wiring 112b. The surface discharge electrode (the first electrode) 110 comprises the scanning electrodes 111 and the common electrodes 112.

The scanning electrode 111 is connected to a scanning electrode driver not illustrated. The common electrode 112 is connected to a common electrode driver not illustrated. The provisions of the low resistive wiring 111b of the scanning electrode and the low resistive wiring 112b of the common electrode 112 make lower line resistances from respective drivers and respective discharge cells as compared to when they are not provided.

A transparent dielectric layer 103 is provided over the first glass substrate 101, wherein the transparent dielectric layer 103 covers the light shielding layers 105 and the surface discharge electrodes 110. A protection layer 104 is formed over the transparent dielectric layer 103. The transparent dielectric layer 103 may, for example, comprise a glass film having a low melting point. The protection layer 104 may, for example, comprise a magnesium oxide thin film.

The back substrate 2 includes a second glass substrate 201 and a plurality of data electrodes 210. The plurality of data electrodes 210 are provided over the second glass substrate 201 for each group of the discharge cells which are aligned in the second direction. The data electrode 210 may, for example, comprise a metal thin film or a metal material containing metal fin particles as a main component. The data electrode 210 is connected to a data electrode driver not illustrated.

A white dielectric layer 205 covering the data electrodes 210 is provided over an area including at least an entirety of the display area over the second glass substrate 201. The white dielectric layer 205 may, for example, comprise a dielectric containing a low melting point glass which becomes white after burning.

Separating walls 220 are formed over the white dielectric layer 205. The separating walls 220 extend in the second direction and along the boundary between the adjacent discharge cells. Stepped portions 203 are also formed over the white dielectric layer 205. The stepped portions 203 are positioned at the boundaries between the adjacent discharge cells in the second direction. In the plan view, the stepped portions 220 overlap the light shielding layers 105 as well as the low resistive wirings 111b and the low resistive wirings 112b. In the plan view, the separating walls 220 overlap connections between the transparent electrodes 111a and the low resistive wirings 111b as well as connections between the transparent electrodes 112a and the low resistive wirings 112b. The height of the separating walls 220 may, for example, correspond substantially to the height of the discharge space 3. The height of the stepped portions 220 may be lower than the height of the discharge space 3. The stepped portion 220 projects in the discharge spade 3, provided that the top of the stepped portion 220 is separated from the protection layer 104 over the first glass substrate 101. A cell gap at a discharge cell boundary area in the presence of the stepped portion 203 is narrower than a cell gap in the discharge cell area in the absence of the stepped portion 203. The stepped portion 203 may, for example, comprise a flat top and a sloped side wall as shown in FIG. 9. The flat top of the stepped portion 203 overlaps, in the plan view, the light shielding layer 105 and the low resistive wiring 111b and the low resistive wiring 112b.

Each of the separating walls 220 and the stepped portions 203 may, for example, comprise a material containing a low melting point glass or an inorganic filler as a main component. A fluorescent layer 202 extends in an area defined by the separating walls 220 and the stepped portions 203. The fluorescent layer 202 may be formed by an application of a fluorescent material.

As a modified example to the configuration shown in FIG. 9, the fluorescent layer 202 may be present over the stepped portions 203. For obtaining a uniform write performance of the discharge cell having the fluorescent layer 202, it is preferable that the fluorescent layer 202 is absent over the stepped portions 203.

The front substrate 1 and the back substrate 2 are bonded to each other so that the tops of the separating walls 220 are in contact with the protection layer 104, and the surface discharge electrodes 110 are perpendicular to the data electrodes 210, whereby the discharge spaces 3 having the same height as the separating walls 220 are formed between the front substrate 1 and the back substrate 2. The discharge space 3 is filled with a discharge gas which comprises a rear gas containing Xe. The discharge gas is introduced after an evacuation. The discharge cells having the discharge spaces 3 are aligned in matrix.

The scanning electrode driver, the common electrode driver, and the data electrode driver are connected to a control circuit not illustrated which controls voltages to be applied to the scanning electrodes 111, the common electrodes 112 and the data electrodes 210.

Descriptions will be made to the method of driving the plasma display panel as configured above in accordance with the first embodiment, provided the respective number of the scanning electrodes 111 and the common electrodes 112 is “n”. The number of the data electrodes 210 is “3×m”. The method utilizes the sub-field method, wherein a single frame comprises a plurality of sub-fields, each of which comprises a reset discharge time period, a selective discharge time period and a discharge time period.

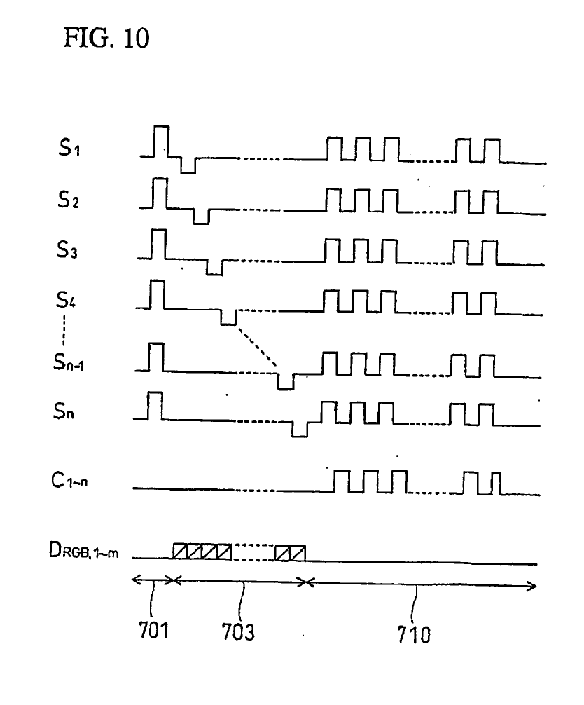

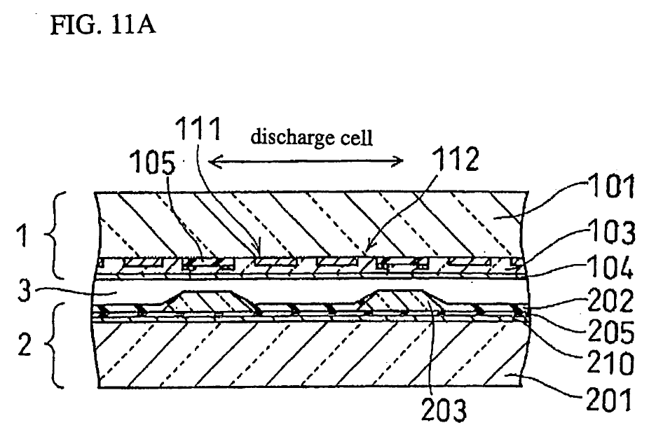

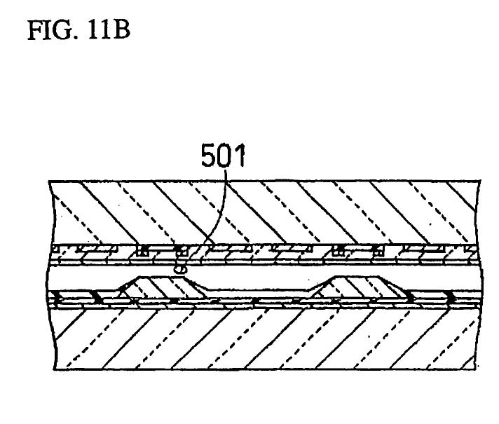

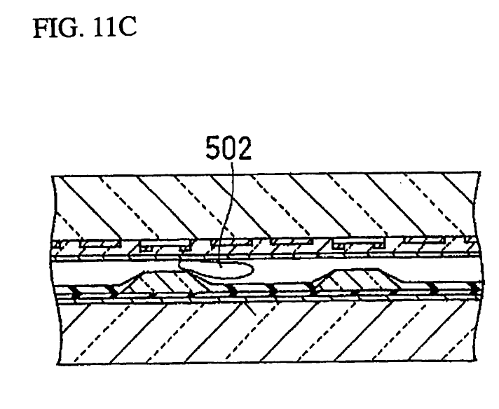

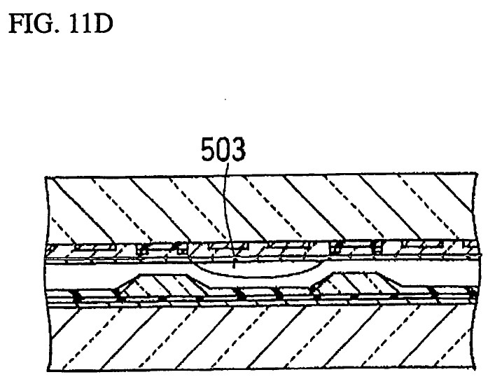

FIG. 10 is a timing chart showing a method of driving the plasma display panel in accordance with the first embodiment of the present invention. In FIG. 10, “Sk” represents a driving waveform of a scanning electrode 111 positioned “k-th” from the top. “C1˜n” represents driving waveforms of all common electrodes 112. “DRGB, 1˜n” represents driving waveforms of data electrodes 210. FIG. 11A is a fragmentary cross sectional view showing a discharge cell in a non-discharge state of the plasma display panel in accordance with the first embodiment of the present invention. FIG. 11B is a fragmentary cross sectional view showing a discharge cell in a weak initial discharge state of the plasma display panel in accordance with the first embodiment of the present invention. FIG. 11C is a fragmentary cross sectional view showing a discharge cell in a transitional discharge state of the plasma display panel in accordance with the first embodiment of the present invention. FIG. 11D is a fragmentary cross sectional view showing a discharge cell in a display discharge state of the plasma display panel in accordance with the first embodiment of the present invention.

In the reset discharge time period 701 of the sub-field, a reset pulse Pr of rectangle-waveform is applied to the scanning electrodes S1 to Sn. As a result, a strong surface discharge is caused between all the scanning electrodes 111 and the common electrodes 112. The discharge is caused at a falling edge of the reset pulse Pr. This means that the wall charges are neutralized in all the discharge cells.

In the selective discharge time period 703, a scanning pulse Ps is sequentially applied to the scanning electrodes S1 to Sn. Data pulses Pd are applied to the data electrodes 210, wherein each data pulse Pd has a low or high level corresponding to the display data. A discharge has the following relationship to the voltage of the scanning pulse Ps and the data pulse Pd of high level. If the data pulse Pd is low level in a discharge cell which is non-selected, then as shown in FIG. 11A, no discharge is caused in this discharge cell. If the data pulse Pd is high level in a discharge cell which is selected, then as shown in FIG. 11B, a weak discharge is caused in this discharge cell, and subsequently this discharge expends to a position under the transparent electrode 111a as shown in FIG. 11C, whereby a transitional discharge 502 is caused.

It is also possible that a potential difference between the scanning electrode and the common electrode is set so that a surface discharge is caused between the scanning electrode and the common electrode following to the above-described write discharge.

In the display discharge time period 710 following to the selective discharge time period 703, based on the weighting previously set in this sub-field, a predetermined number of sustaining discharge pulse Psus-s is applied to all the scanning electrodes 111 as well as a predetermined number of sustaining discharge pulse Psus-c is applied to all the common electrodes 112. The sustaining discharge pulse Psus-s applied to the scanning electrodes 111 is different in phase by 180 degrees from the sustaining discharge pulse Psus-c applied to the common electrodes 112. The sustaining discharge pulse Psus-s and the sustaining discharge pulse Psus-c are applied to all the scanning electrodes 111 and all the common electrodes 112 respectively, whereby a display discharge 503 is caused in the discharge cell selected in the selective discharge time period 703 as shown in FIG. 11D. In the discharge cell non-selected in the selective discharge time period 703, no discharge is caused during the display discharge time period 710, wherein the non-selected discharge cell is in the non-luminescent state.

It is also possible that the width or the voltage of the initial sustaining discharge pulse and subsequent plural sustaining discharge pulses may be larger than the width or the voltage of the sustaining discharge pulses in a last half of the display discharge time period 710, for continuation to the display discharge in the discharge cell, in which the write discharge was generated.

The similar driving will be made to the above-described field from the next sub-field to the last sub-field in the single frame, with changing the number of the sustaining discharge pulses Psus-s applied to the scanning electrodes 111 based on the weight as well as changing the number of the sustaining discharge pulses Psus-c applied to the common electrodes 112 based on the weight.

In accordance with the first embodiment, the write discharge in the selective discharge time period is generated at the edge of the discharge cell and then expanded to the center of the discharge cell. Only in the selection with applying both the scanning pulses and the data pulses simultaneously, a weak discharge 501 is caused, and subsequently this weak discharge 501 expands to the center of the discharge cell and a discharge 502 is generated, whereby the discharge cell is selected. In connection with the control to the discharge, the weak discharge 501 is generated by a relatively low voltage, for which reason it is possible to improve a high speed performance and reduce the necessary voltage, as compared to the conventional control.

The present inventor has made a plasma display panel in accordance with this embodiment and investigated the widths of the scanning pulses Ps and the data pulses Pd and confirmed the following results. The scanning pulses and the data pulses, both of which are synchronously applied, are varied in width with keeping the discharge type in the above-described selection. Even if a write discharge is generated at a timing at least 1 millisecond after the end of the reset discharge time period 701, then a certain transition to the display discharge is caused with a pulse width of not longer than 1.2 microseconds.

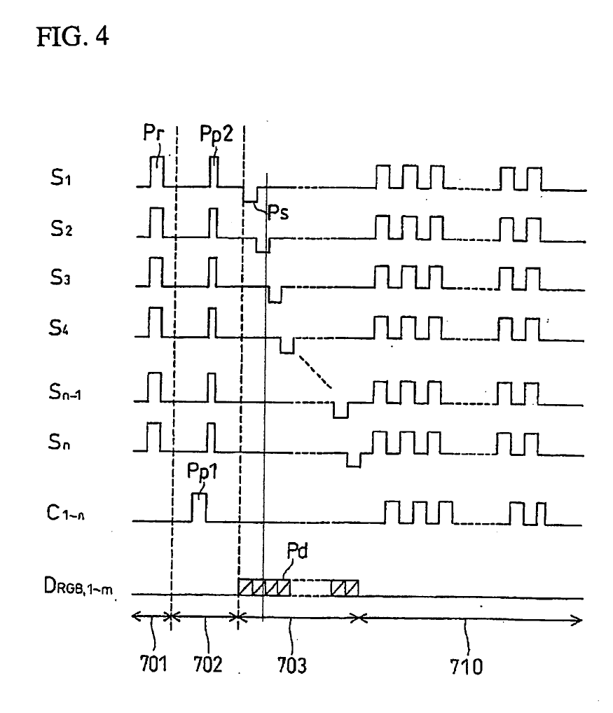

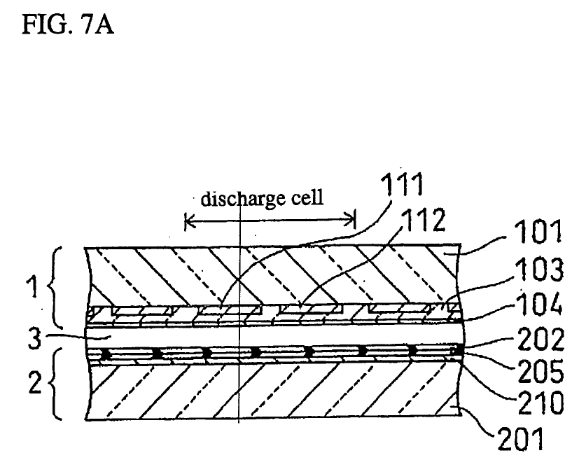

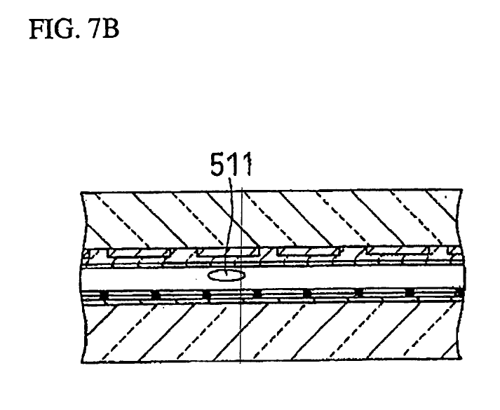

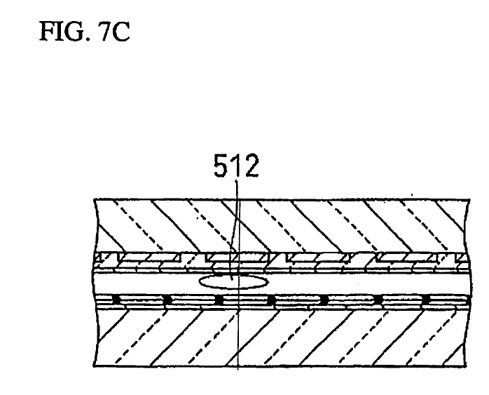

As a comparison, the conventional plasma display panel shown in FIG. 7A was prepared, wherein the pitch of the discharge cells and the distance between the discharge spaces at the centers of the discharge cells are the same as described above. The same driving is made under the conventional control with the selective discharge as shown in FIG. 4. If a passing time from the end of the reset discharge time period is relatively small, then the same pulse width can be used for driving as in the first embodiment. If the passing time exceeds 1 millisecond, then 2 microseconds or longer pulse width was needed.

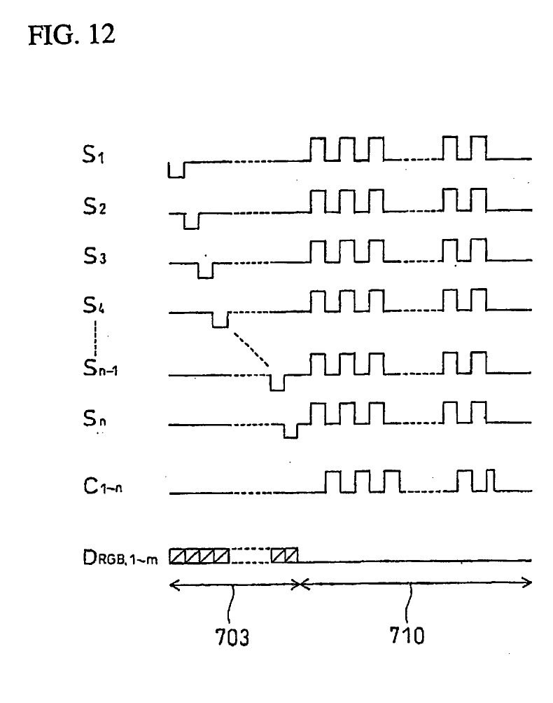

FIG. 12 is a timing chart showing another method of driving the plasma display panel in accordance with the first embodiment of the present invention. In accordance with the first embodiment, as shown in FIG. 10, the reset discharge time period 701, the selective discharge time period 703 and the display discharge time period 710 are provided in the sub-field. A large flexibility is given to the voltages applied to the resent discharge time period and the priming discharge time period. Accordingly, it is possible that as shown in the timing chart of FIG. 12, in a sub-field, the reset discharge time period 701 is not provided, while the selective discharge time period 703 and the display discharge time period 710 are provided.

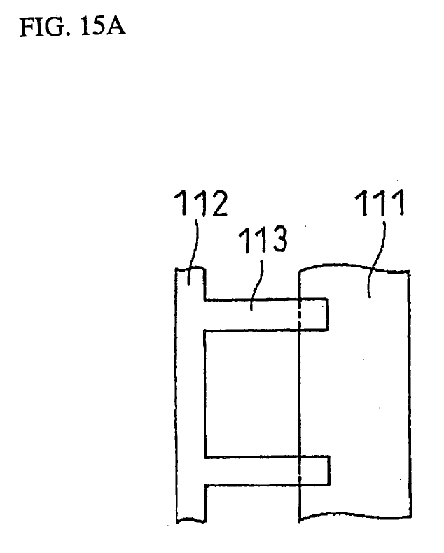

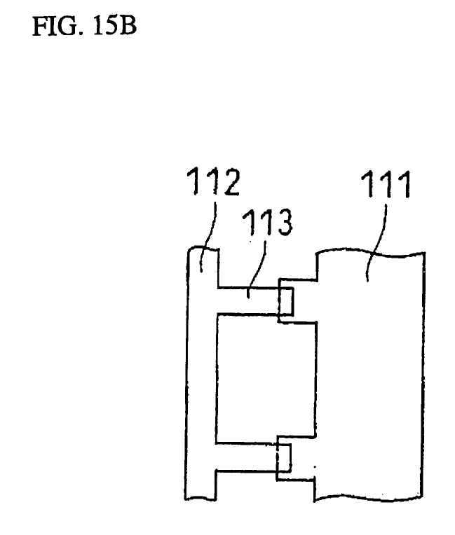

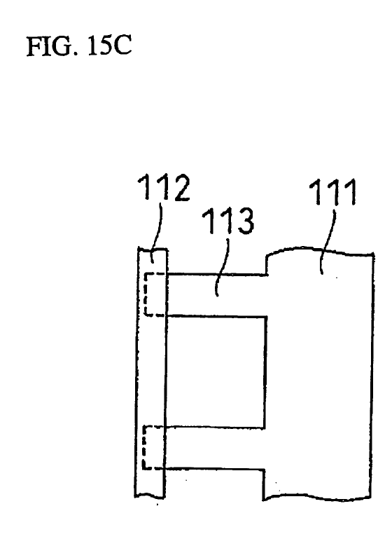

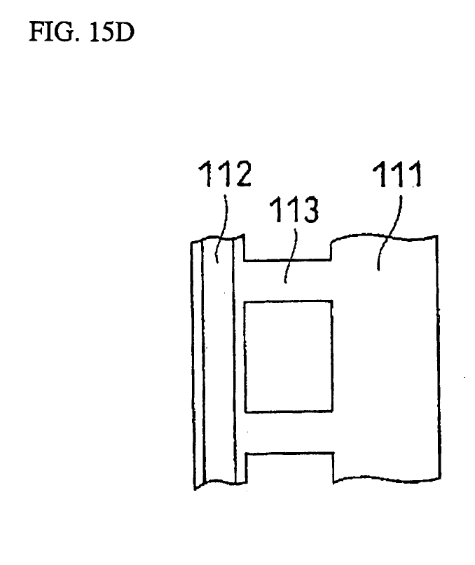

FIG. 15A is a fragmentary plan view showing an example of a connection structure between a transparent electrode and a low resistive wiring. FIG. 15B is a fragmentary plan view showing another example of a connection structure between a transparent electrode and a low resistive wiring. FIG. 15C is a fragmentary plan view showing another example of a connection structure between a transparent electrode and a low resistive wiring. FIG. 15D is a fragmentary plan view showing another example of a connection structure between a transparent electrode and a low resistive wiring.

There are no particular limitations to materials and structures of the connection between the transparent electrode 111a and 111b and the low resistive wirings 112a and 112b. As shown in FIG. 15A, a connection 113 may comprise the same material as the low resistive wiring 112 and may be united with the low resistive wiring 112, and the connection 113 may provide a connection between the transparent electrode 111 and the low resistive wiring 112. As shown in FIG. 15B, a connection 113 may comprise different parts overlapping each other, wherein the first part comprises the same material as the low resistive wiring 112 and is united with the low resistive wiring 112 and the second part comprises the same material as the transparent electrode 111 and is united with the transparent electrode 111. As shown in FIG. 15C, a connection 113 may comprise the same material as the transparent electrode 111 and may be united with the transparent electrode 111, and the connection 113 may provide a connection between the transparent electrode 111 and the low resistive wiring 112. As shown in FIG. 15D, a connection 113 may comprise the same material as the transparent electrode 111 and may be united with the transparent electrode 111, and also overlaps the entirety of the low resistive wiring 112.

The position of the connection may be displaced from the separating walls in the plan view or within the discharge cell area, provided that a width of the connection is not wider than about 20 micrometers.

Each of the low resistive wirings 112a and 112b may, as described above, comprise a thin film conductive material or a metal material and a material including metal fine particles as a main component. There is no particular limitation to the shape of the low resistive wirings. If the single low resistive wiring has a width of not wider than about 20 micrometers, provided that not more than 3 fin lines form the single wiring, then it is possible to prevent any remarkable deterioration to the luminescent property.

In connection with the positional relationship between the stepped portions and the separating walls, it is possible that the stepped portions extend perpendicular to the separating walls and overlap the separating walls at crossing points.

### SECOND EMBODIMENT

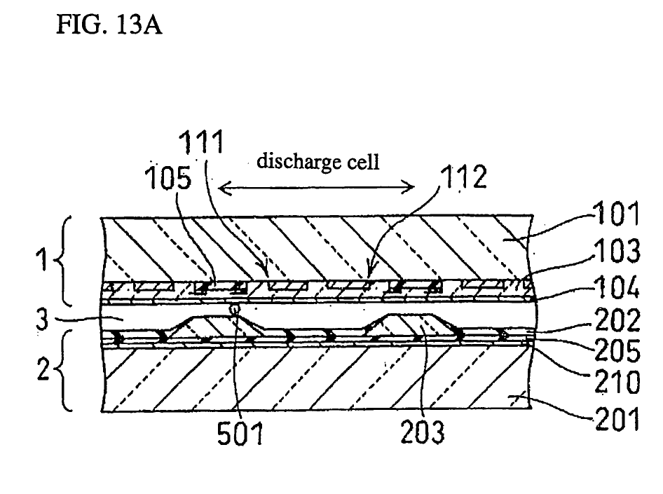

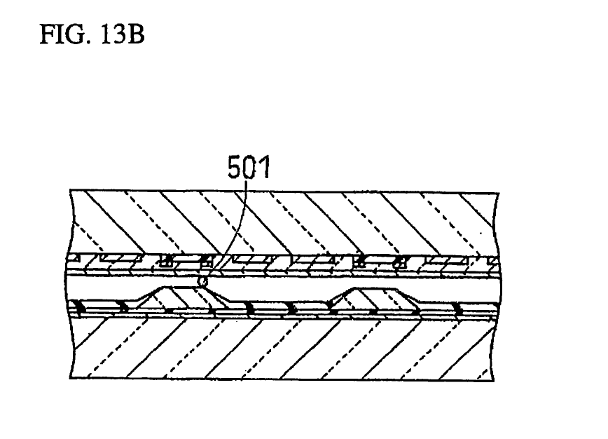

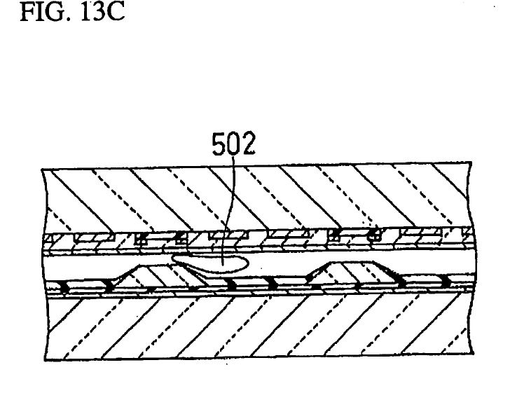

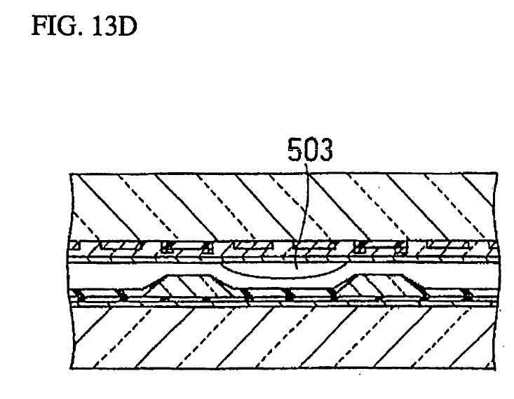

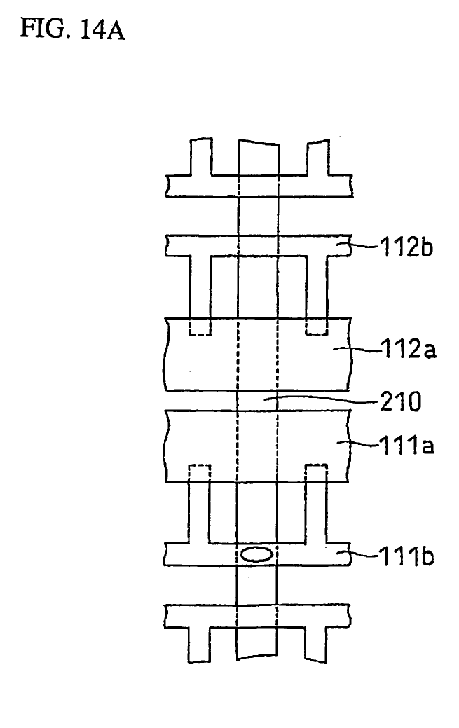

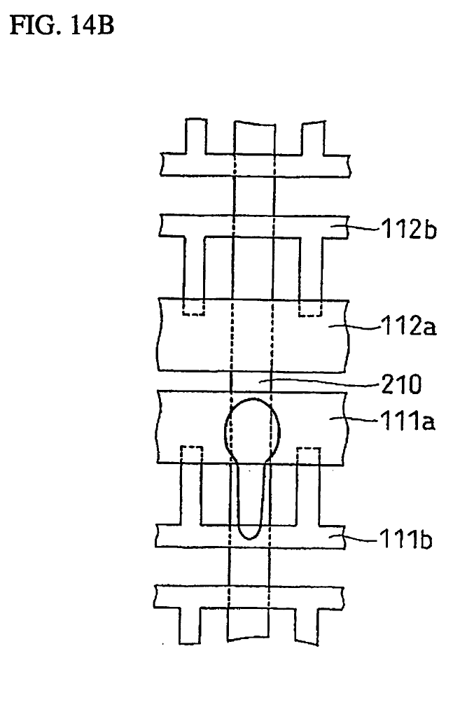

A second embodiment of the present invention will be described. FIG. 13A is a fragmentary cross sectional view showing a discharge cell in a non-discharge state of the plasma display panel in accordance with the second embodiment of the present invention. FIG. 13B is a fragmentary cross sectional view showing a discharge cell in a weak initial discharge state of the plasma display panel in accordance with the second embodiment of the present invention. FIG. 13C is a fragmentary cross sectional view showing a discharge cell in a transitional discharge state of the plasma display panel in accordance with the second embodiment of the present invention. FIG. 13D is a fragmentary cross sectional view showing a discharge cell in a display discharge state of the plasma display panel in accordance with the second embodiment of the present invention. FIG. 14A is a fragmentary cross sectional view showing a discharge cell in a weak initial discharge state of the plasma display panel in accordance with the second embodiment of the present invention. FIG. 14B is a fragmentary cross sectional view showing a discharge cell in a display discharge state of the plasma display panel in accordance with the second embodiment of the present invention.

The structure of the discharge cell of the plasma display panel in accordance with the second embodiment is identical with that of the first embodiment. The second embodiment is different from the first embodiment in the method of driving the plasma display panel.

In the second embodiment, in the selective discharge time period 703, the scanning pulse Ps is sequentially applied to the scanning electrodes S1 to Sn. Data pulses Pd are applied to the data electrodes 210, wherein each data pulse Pd has a low or high level corresponding to the display data. The voltage of the scanning pulse Ps and the data pulse Pd of high level are set so as to cause the following. If the data pulse Pd is low level in a discharge cell which is non-selected, then as shown in FIG. 13A and FIG. 14A, a weak discharge 501 is caused in an area, in which the low resistive wiring 111b overlaps the stepped portion 203 over the data electrode 210. If the data pulse Pd is high level in a discharge cell which is selected, then as shown in FIG. 13B, a weak discharge 501 is caused in this discharge cell immediately after the application of the data pulse Pd, and subsequently this discharge expends to a position under the transparent electrode 111a as shown in FIG. 13C and FIG. 14B, whereby a transitional discharge 502 is caused.

As shown in FIG. 13A, FIG. 13B as well as FIG. 14A, the weak discharge 501 is caused in a local area. If the light shielding layers 105 are not provided, then this weak discharge 501 can be observed as a discharge luminescence synchronizing with the scanning pulses Ps. The weak discharge 501 can also be observed by a weal luminescence of the fluorescent layer 202 at the edge of the light shielding layer 105.

In the display discharge time period 710 following to the selective discharge time period 703, based on the weighting previously set in this sub-field, a predetermined number of sustaining discharge pulse Psus-s is applied to all the scanning electrodes 111 as well as a predetermined number of sustaining discharge pulse Psus-c is applied to all the common electrodes 112. The sustaining discharge pulse Psus-s applied to the scanning electrodes 111 is different in phase by 180 degrees from the sustaining discharge pulse Psus-c applied to the common electrodes 112. The sustaining discharge pulse Psus-s and the sustaining discharge pulse Psus-c are applied to all the scanning electrodes 111 and all the common electrodes 112 respectively, whereby a display discharge 503 is caused in the discharge cell selected in the selective discharge time period 703 as shown in FIG. 13D. In the discharge cell non-selected in the selective discharge time period 703, no discharge is caused during the display discharge time period 710, wherein the non-selected discharge cell is in the non-luminescent state.

The similar driving will be made to the above-described field from the next sub-field to the last sub-field in the single frame, with changing the number of the sustaining discharge pulses Psus-s applied to the scanning electrodes 111 based on the weight as well as changing the number of the sustaining discharge pulses Psus-c applied to the common electrodes 112 based on the weight.

In accordance with the second embodiment, the write discharge in the selective discharge time period is generated at the edge of the discharge cell and then expanded to the center of the discharge cell. Even if reductions in width of the scanning pulses Ps and the data pulses Pd without any priming discharge prior to each elective discharge time period causes a sufficient write discharge. This realizes a further improvement in the high speed performance of the write discharge as compared to the first embodiment, wherein any weak discharge is not generated in the non-discharge state. It is also possible to reduce the amplitude of the voltage of the data pulse Pd for reducing the necessary voltage.

The present inventor has made a plasma display panel in accordance with this embodiment and investigated the widths of the scanning pulses Ps and the data pulses Pd and confirmed the following results. The scanning pulses and the data pulses, both of which are synchronously applied, are varied in width with keeping the discharge type in the above-described selection. Even if a write discharge is generated at a timing at least 1 millisecond after the end of the reset discharge time period 701, then a certain transition to the display discharge is caused with a pulse width of not longer than 1 microsecond. As a comparison, the conventional plasma display panel shown in FIG. 7A, FIG. 7B and FIG. 7C was prepared, wherein the pitch of the discharge cells and the distance between the discharge spaces at the centers of the discharge cells are the same as described above. The same driving is made under the conventional control with the selective discharge as shown in FIG. 4. If a passing time from the end of the reset discharge time period is relatively small, then the same pulse width can be used for driving as in the first embodiment. If the passing time exceeds 1 millisecond, then 2 microseconds or longer pulse width was needed.

The second embodiment makes unnecessary a strong discharge at the reset. Since the light shielding layers 105 shield the luminescence of the weak discharge 501 at the edge of the discharge cell in the selective discharge time period 703, this makes it possible to reduce the brightness of the black display to be extremely small and also improve the contrast for improving the image quality.

In accordance with this embodiment, the weak discharge 501 applies the voltage to the wall charges accumulated in the discharge cell including this discharge area, wherein an opposite electric field is generated across the scanning electrodes 111 and the data electrodes 210 in an initial time period of the display discharge time period 710, for which reason a weak discharge is generated for forming charges which cancel the accumulated wall charges.

As a modified embodiment to the second embodiment, only in the selected discharge cell, a discharge is generated, which neutralizes the wall charges accumulated in the discharge cell through the display discharge at the time of the end of the display discharge time period 710 for causing no strong discharge in the reset discharge time period 701 in the next sub-field. In this case, the improvement in the high speed performance and the reduction in the necessary voltage can be realized similarly to the case that the strong discharge is caused in the reset discharge time period 701. In connection with the control to the discharge type of the conventional selective discharge, if any strong discharge is generated in the reset discharge time period 701, then this makes it quite difficult to cause write discharges 511 and 512.

In accordance with this embodiment, similarly to the above described embodiment, there are no particular limitations to materials and structures of the connection between the transparent electrode 111a and 111b and the low resistive wirings 112a and 112b. As shown in FIG. 15A, a connection 113 may comprise the same material as the low resistive wiring 112 and may be united with the low resistive wiring 112, and the connection 113 may provide a connection between the transparent electrode 111 and the low resistive wiring 112. As shown in FIG. 15B, a connection 113 may comprise different parts overlapping each other, wherein the first part comprises the same material as the low resistive wiring 112 and is united with the low resistive wiring 112 and the second part comprises the same material as the transparent electrode 111 and is united with the transparent electrode 111. As shown in FIG. 15C, a connection 113 may comprise the same material as the transparent electrode 111 and may be united with the transparent electrode 111, and the connection 113 may provide a connection between the transparent electrode 111 and the low resistive wiring 112. As shown in FIG. 15D, a connection 113 may comprise the same material as the transparent electrode 111 and may be united with the transparent electrode 111, and also overlaps the entirety of the low resistive wiring 112.

The position of the connection may be displaced from the separating walls in the plan view or within the discharge cell area, provided that a width of the connection is not wider than about 20 micrometers.

Each of the low resistive wirings 112a and 112b may, as described above, comprise a thin film conductive material or a metal material and a material including metal fine particles as a main component. There is no particular limitation to the shape of the low resistive wirings. If the single low resistive wiring has a width of not wider than about 20 micrometers, provided that not more than 3 fin lines form the single wiring, then it is possible to prevent any remarkable deterioration to the luminescent property.

In connection with the positional relationship between the stepped portions and the separating walls, it is possible that the stepped portions extend perpendicular to the separating walls and overlap the separating walls at crossing points.

### THIRD EMBODIMENT

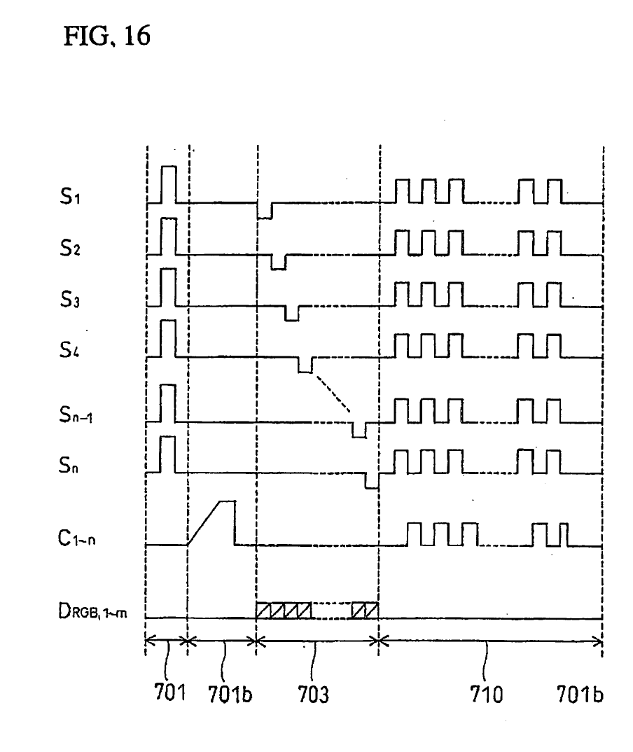

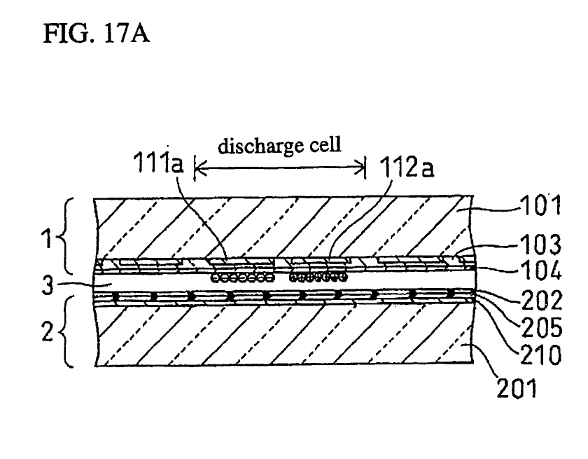

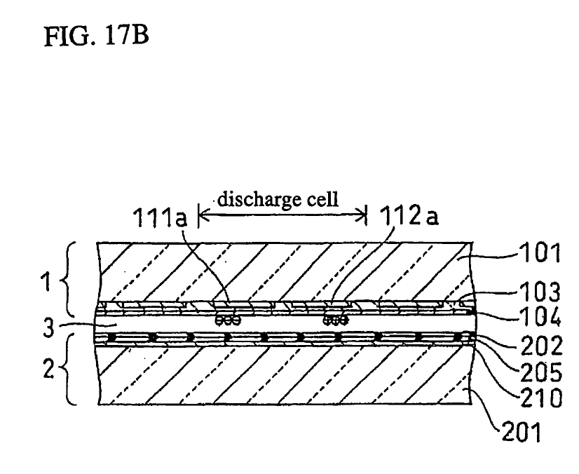

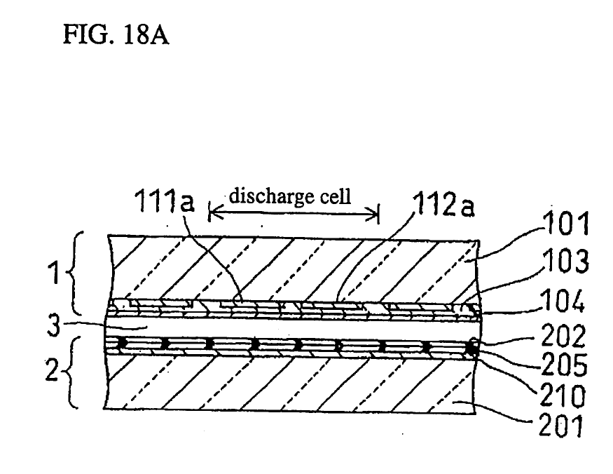

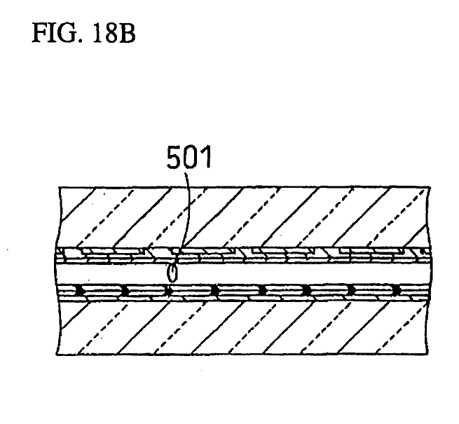

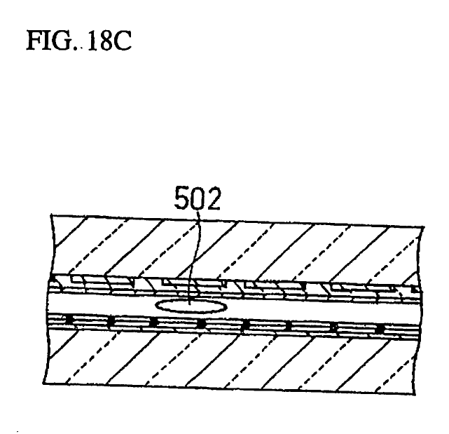

A third embodiment of the present invention will be described. In this third embodiment, the novel method of driving the conventional plasma display panel shown in FIGS. 7A, 7B, and 7C. FIG. 16 is a timing chart showing another method of driving the plasma display panel in accordance with the third embodiment of the present invention. FIG. 17A is a cross sectional view showing a uniform distribution of wall charges of a discharge cell of the plasma display panel in accordance with the third embodiment of the present invention. FIG. 17A is a cross sectional view showing a local distribution of wall charges of a discharge cell of the plasma display panel in accordance with the third embodiment of the present invention. FIG. 18A is a fragmentary cross sectional view showing a discharge cell in a non-discharge state of the plasma display panel in accordance with the third embodiment of the present invention. FIG. 18B is a fragmentary cross sectional view showing a discharge cell in a weak initial discharge state of the plasma display panel in accordance with the third embodiment of the present invention. FIG. 18C is a fragmentary cross sectional view showing a discharge cell in a display discharge state of the plasma display panel in accordance with the third embodiment of the present invention.

In accordance with the third embodiment, a gap portion discharge timer period 701b is provided between the reset discharge time period 701 and the selective discharge time period 703. In the reset discharge time period 701, a surface discharge is generated between the scanning electrodes 111 as positive electrodes and the common electrodes 112. In the gap portion discharge timer period 701b, a pulse of sloped waveform is applied to the common electrodes 112 for causing a surface discharge of opposite polarity by the sloped waveform, thereby neutralizing the wall charges accumulated in the vicinity of the gap between the surface discharges. After the reset discharge time period 701, as shown in FIG. 17A, wall charges are formed and expend to the entirety of the dielectric layer 103 over the surface discharge electrodes 110. In the gap portion discharge timer period 701b, a voltage of a sloped waveform is applied for causing a discharge limited in a surface discharge gap periphery area only, so that as shown in FIG. 17B, a non-uniform distribution of wall charges over the scanning electrodes 111 is caused, whereby desired wall charges reside only in the vicinity of the non-discharge gap. As a result, in the selective discharge time period 703, an opposite discharge can easily be caused between the discharge cell edge area of the scanning electrode 111 and the data electrode 210. Accordingly, as shown in FIG. 18B, in the initial period of the selective discharge time period, the weak discharge 501 is generated but only at the discharge cell edge, and subsequently, as shown in FIG. 18C, the discharge 503 expended to the entirety of the scanning electrodes 111 can be obtained. Therefore, similarly to the first embodiment, it is possible to improve the high speed performance and reduce the necessary voltage. No selective discharge is generated in the non-selected discharge cell as shown in FIG. 18A.

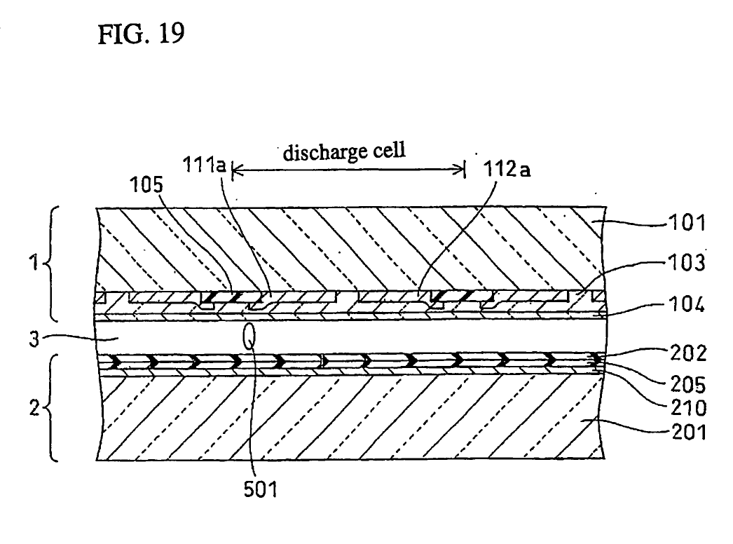

FIG. 19 is a fragmentary plan view showing a modified example of a configuration of the plasma display panel in accordance with the third embodiment of the present invention. As a modified example shown in FIG. 19 to the third embodiment, the light shielding layers 105 are provided on the boundaries between the adjacent discharge cells in the vertical direction for improving the contrast for improving the image quality. As shown in FIG. 14, the surface discharge electrodes 110 and the light shielding layers 105 are overlapped each other. This overlap is unnecessary, provided that the width of the light shielding layers 105 is sufficient for shielding the visible light caused by the slight discharge generated in selection at the periphery of the discharge cell.

### FOURTH EMBODIMENT

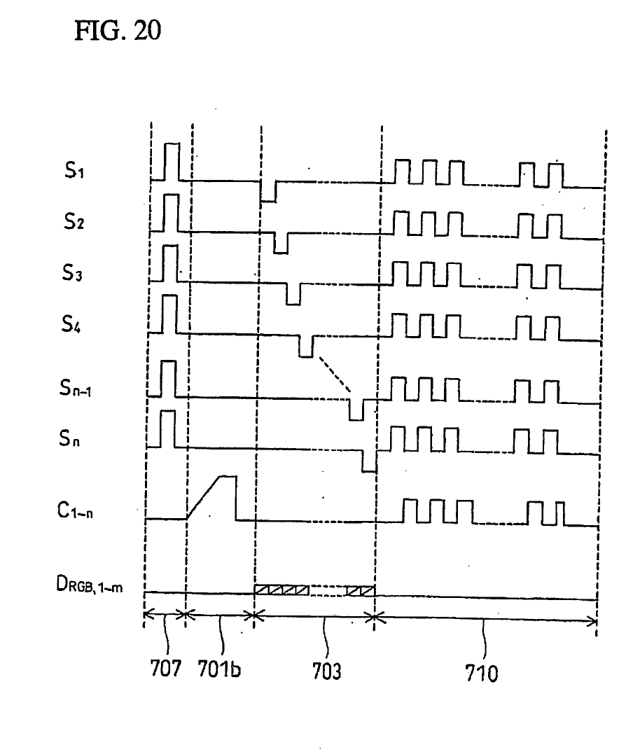

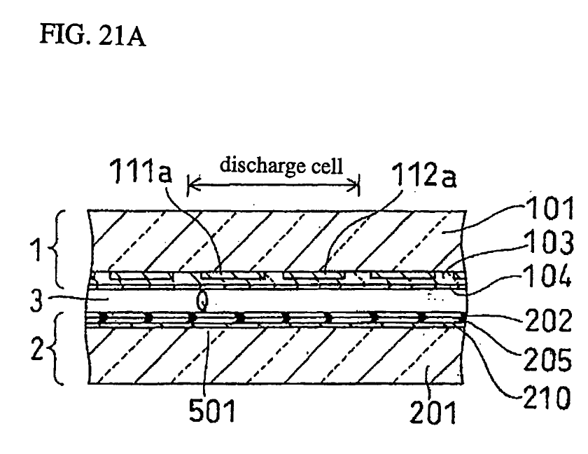

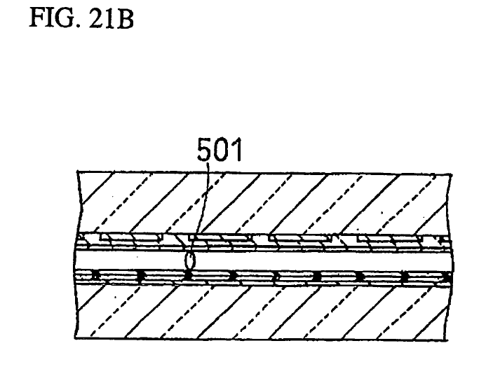

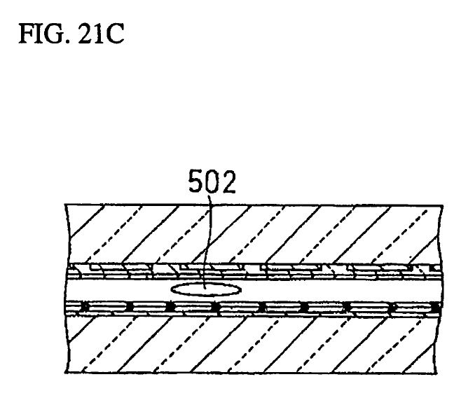

A fourth embodiment of the present invention will be described. In this fourth embodiment, the novel method of driving the conventional plasma display panel shown in FIGS. 7A, 7B, and 7C. FIG. 20 is a timing chart showing another method of driving the plasma display panel in accordance with the fourth embodiment of the present invention. FIG. 21A is a fragmentary cross sectional view showing a discharge cell in a weak initial discharge state of the plasma display panel in accordance with the fourth embodiment of the present invention. FIG. 21B is a fragmentary cross sectional view showing a discharge cell in a transitional discharge state of the plasma display panel in accordance with the fourth embodiment of the present invention. FIG. 21C is a fragmentary cross sectional view showing a discharge cell in a display discharge state of the plasma display panel in accordance with the fourth embodiment of the present invention.

In accordance with the fourth embodiment, a gap portion discharge timer period 701b is provided before the selective discharge time period 703 for controlling the distribution of the wall charges. For example, the voltage of the scanning pulse is increased while the data pulse voltage is decreased as compared to the above-described third embodiment, so that as shown in FIG. 21A, a weak discharge 501 is generated at a limited area of the discharge cell non-selected. In the selected discharge cell, the weak discharge 501 as shown in FIG. 21B is transitioned to the strong discharge as shown in FIG. 21C. Therefore, similarly to the second embodiment, it is possible to improve the high speed performance and reduce the necessary voltage.

As a modified embodiment to the fourth embodiment, as shown in FIG. 19, the light shielding layers 105 are provided on the boundaries between the adjacent discharge cells in the vertical direction for improving the contrast for improving the image quality. As shown in FIG. 14, the surface discharge electrodes 110 and the light shielding layers 105 are overlapped each other. This overlap is unnecessary, provided that the width of the light shielding layers 105 is sufficient for shielding the visible light caused by the slight discharge generated in selection at the periphery of the discharge cell.

### FIFTH EMBODIMENT

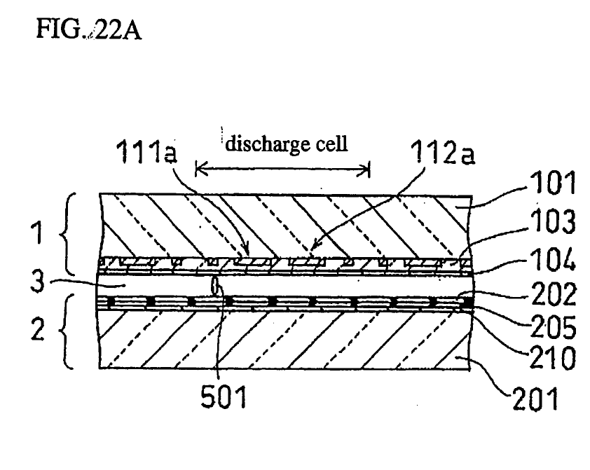

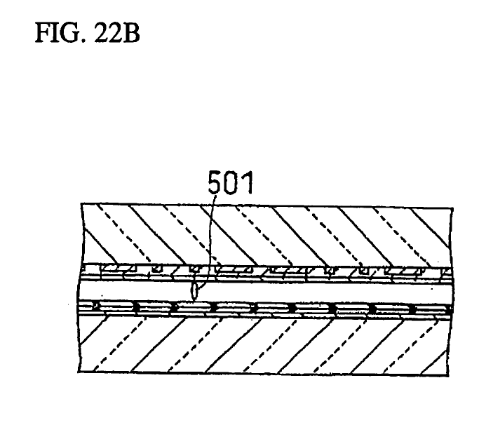

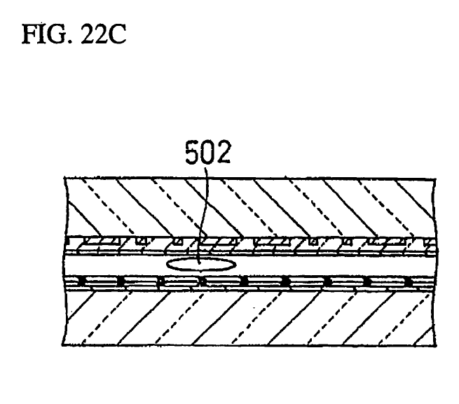

A fifth embodiment of the present invention will be described. This fifth embodiment is identical with the above-described second embodiment except that the light shielding layers 105 and the stepped portions 203 are not provided. The scanning electrode 111 comprises the transparent electrode 111a and the low resistive wiring 111b. The common electrodes 112 comprises the transparent electrode 112a and the low resistive wiring 112b. FIG. 22A is a fragmentary cross sectional view showing a discharge cell in a weak initial discharge state of the plasma display panel in accordance with the fifth embodiment of the present invention. FIG. 22B is a fragmentary cross sectional view showing a discharge cell in a transitional discharge state of the plasma display panel in accordance with the fifth embodiment of the present invention. FIG. 22C is a fragmentary cross sectional view showing a discharge cell in a display discharge state of the plasma display panel in accordance with the fifth embodiment of the present invention.

In accordance with the fifth embodiment, in the initial period of the selective discharge time period, as shown in FIG. 22A, a weak discharge 501 is generated at the edge of the non-selected discharge cell and further as shown in FIG. 22B, the weak discharge 501 is generated in the selected discharge cell. The caution is that an area of the low resistive wiring is remarkably smaller than the area of the transparent electrode and thus the discharge initiation voltage at the edge of the discharge cell is lower than that at the other position. In the selected discharge cell, as shown in FIG. 22C, the discharge 501 expends and is transitioned to the discharge 502, while in the non-selected discharge cell, the discharge becomes disappeared.

In accordance with the fifth embodiment, it is possible to control properly the expansion of the weak discharge 501 generated at the edge of the discharge cell for a stable generation of the discharge 501 in the non-selected or selected discharge cell. Therefore, similarly to the second embodiment, it is possible to improve the high speed performance and reduce the necessary voltage.

### SIXTH EMBODIMENT

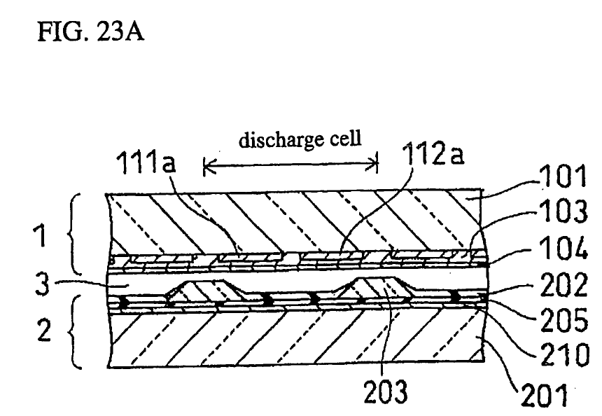

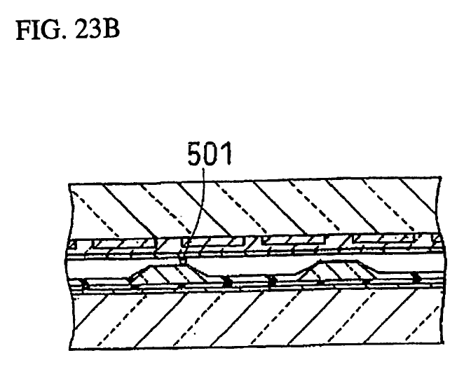

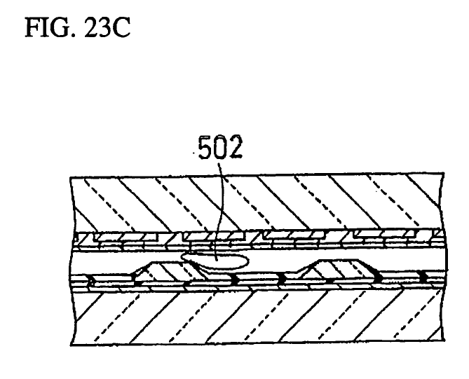

A sixth embodiment of the present invention will be described. This sixth embodiment is identical with the above-described first embodiment except that the light shielding layers 105 are not provided, and that each of the scanning electrodes 111 and the common electrodes 112 comprises only the transparent electrode. The stepped portions 203 are provided on the boundaries between the adjacent discharge cells in the vertical direction. FIG. 23A is a fragmentary cross sectional view showing a discharge cell in a non-discharge state of the plasma display panel in accordance with the sixth embodiment of the present invention. FIG. 23B is a fragmentary cross sectional view showing a discharge cell in a weak initial discharge state of the plasma display panel in accordance with the sixth embodiment of the present invention. FIG. 23C is a fragmentary cross sectional view showing a discharge cell in a display discharge state of the plasma display panel in accordance with the sixth embodiment of the present invention.

In accordance with the sixth embodiment, in the initial period of the selective discharge time period, as shown in FIG. 23A, no discharge is caused in the non-selected discharge cell, while as shown in FIG. 23B, the weak discharge 501 is generated in the selected discharge cell. In the selected discharge cell, as shown in FIG. 23C, the discharge 501 expends and is transitioned to the discharge 502.

In accordance with the sixth embodiment, it is possible to control properly the expansion of the weak discharge 501 generated at the edge of the discharge cell for a stable generation of the discharge 501 in the non-selected or selected discharge cell. Therefore, similarly to the second embodiment, it is possible to improve the high speed performance and reduce the necessary voltage.

### SEVENTH EMBODIMENT

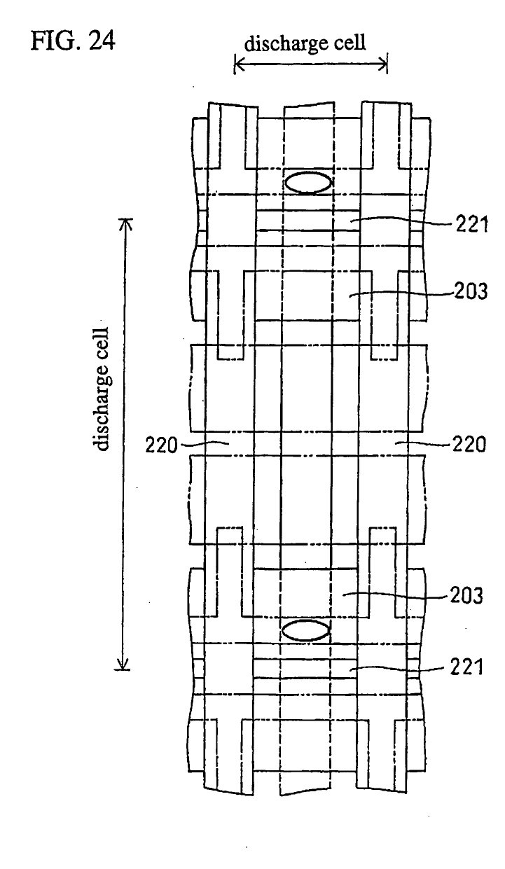

A seventh embodiment of the present invention will be described. FIG. 24 is a fragmentary plan view showing a configuration over a back substrate of a plasma display panel in accordance with the seventh embodiment of the present invention. In the seventh embodiment as shown in FIG. 24, additional separating walls 221 are formed over the stepped portions 203 and the additional separating walls 221 extend in the direction perpendicular to the separating walls 220. The height of the additional separating walls 221 from the white dielectric layer 205 almost corresponds to that of the separating walls 220.

In the seventh embodiment, suppression is highly ensured to the expansion of the weak discharge 501 generated at the edge of the discharge cell toward the adjacent discharge cell in the vertical direction. Accordingly, further reductions can be obtained to the luminescent intensity and the discharge current of this weak discharge 501, thereby making it possible that the improvement of the high speed performance and the reduction of the necessary voltage are realized with keeping a wide available range for the scanning pulse voltage and the data pulse voltage.

It is preferable that the stepped portions 203 are provided in the seventh embodiment. As a modified embodiment to the seventh embodiment, it is also possible that the stepped portions 203 are not provided.

The present inventor has investigated a relationship of the discharge gas and the range of the selective discharge and confirmed the followings. In the components of the discharge gas, Xe, Kr, Ar or nitrogen is to generate an ultraviolet light which mainly excites the fluorescent material. If a partial pressure of its component is not less than 100 hPa, then a further effective suppression can be obtained to the expansion of the weak discharge gas 501 generated at the edge of the discharge cell. In case of using such discharge gas, the control by the conventional discharge mode in the selected discharge cell allows a further large width of the pulse voltage necessary for the write. In accordance with this embodiment, the increase in the width of the pulse voltage is extremely small. In case of using such discharge gas, it is possible that the discharge initiation voltage of the surface discharge is larger than the discharge initiation voltage of the opposite discharge, thereby making it difficult to control the selective discharge. In order to avoid this trouble, it is effective to reduce the thickness of the dielectric layer within and in the vicinity of the discharge gap area of the surface discharge. This structure allows setting the discharge initiation voltage of the surface discharge at an appropriate value for controlling the discharge mode in accordance with this embodiment.

### EIGHTH EMBODIMENT

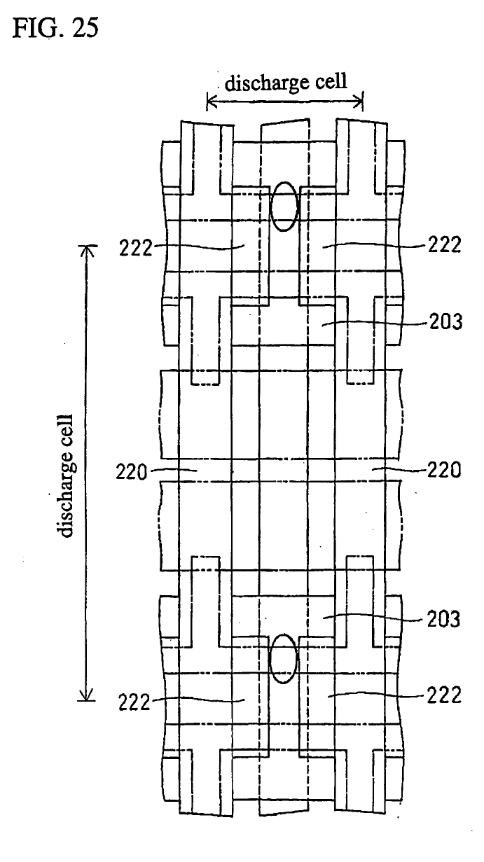

An eighth embodiment of the present invention will be described. FIG. 25 is a fragmentary plan view showing a configuration over a back substrate of a plasma display panel in accordance with the eighth embodiment of the present invention. In the eighth embodiment as shown in FIG. 25, additional separating walls 222 are formed over the stepped portions 203 and the additional separating walls 222 are in contact with the separating walls 220 and are to ensure a gap between adjacent additional separating walls 222. The additional separating walls 222 extend in parallel to the separating walls 220 and at a distance identical with the width of the light shielding layers 105. The height of the additional separating walls 222 from the white dielectric layer 205 almost corresponds to that of the separating walls 220.

In the eighth embodiment, the same effects as the seventh embodiment can be obtained. Further, the evacuation conductance necessary for the evacuation of the discharge space is higher than the seventh embodiment.

It is preferable that the stepped portions 203 are provided in the eighth embodiment. As a modified embodiment to the eighth embodiment, it is also possible that the stepped portions 203 are not provided.

The present inventor has investigated a relationship of the discharge gas and the range of the selective discharge and confirmed the followings. In the components of the discharge gas, Xe, Kr, Ar or nitrogen is to generate an ultraviolet light which mainly excites the fluorescent material. If a partial pressure of its component is not less than 100 hPa, then a further effective suppression can be obtained to the expansion of the weak discharge gas 501 generated at the edge of the discharge cell. In case of using such discharge gas, the control by the conventional discharge mode in the selected discharge cell allows a further large width of the pulse voltage necessary for the write. In accordance with this embodiment, the increase in the width of the pulse voltage is extremely small. In case of using such discharge gas, it is possible that the discharge initiation voltage of the surface discharge is larger than the discharge initiation voltage of the opposite discharge, thereby making it difficult to control the selective discharge. In order to avoid this trouble, it is effective to reduce the thickness of the dielectric layer within and in the vicinity of the discharge gap area of the surface discharge. This structure allows setting the discharge initiation voltage of the surface discharge at an appropriate value for controlling the discharge mode in accordance with this embodiment.

### NINTH EMBODIMENT

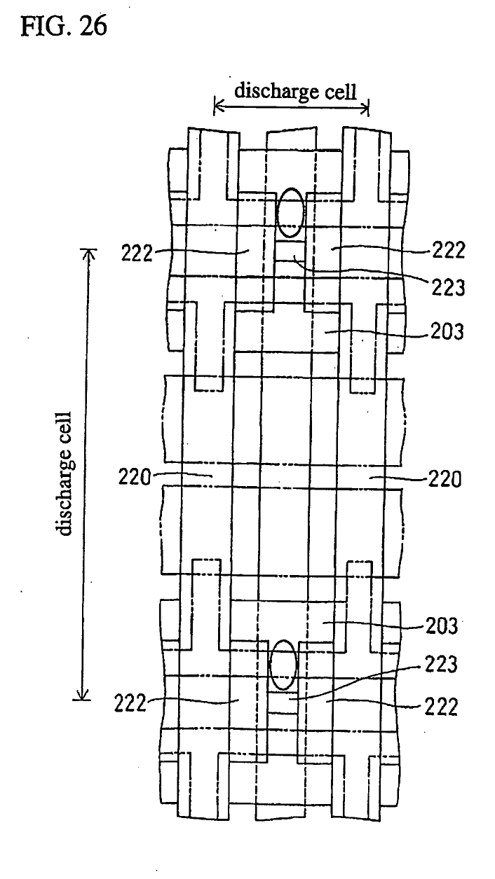

A ninth embodiment of the present invention will be described. FIG. 26 is a fragmentary plan view showing a configuration over a back substrate of a plasma display panel in accordance with the ninth embodiment of the present invention. In the ninth embodiment as shown in FIG. 26, a separating wall 223 is formed between the opposite separating walls 222. The separating wall 223 is positioned in plan view between the low resistive wiring 111b and the low resistive wiring 112b. The height of the additional separating wall 223 from the white dielectric layer 205 almost corresponds to that of the separating walls 220.

In accordance with the ninth embodiment, it is possible that the weak discharge 501 is generated within a more limited area at the edge of the discharge cell as compared to the eighth embodiment. It is possible to improve the high speed performance and reduce the necessary voltage with suppressing the power necessary for generating the weak discharge 501.

In accordance with the ninth embodiment, a concave portion as a discharge area over the stepped portion 203 is provided symmetrically with reference to both discharge cells positioned in opposite sides of the stepped portion 203. As a modified embodiment to the ninth embodiment, it is also possible that the concave portion is formed but only in the side of the scanning electrode 111 because the selective discharge is not caused between the common electrode 112 and the data electrode 210.

It is preferable that the stepped portions 203 are provided in the ninth embodiment. As a modified embodiment to the ninth embodiment, it is also possible that the stepped portions 203 are not provided.

The present inventor has investigated a relationship of the discharge gas and the range of the selective discharge and confirmed the followings. In the components of the discharge gas, Xe, Kr, Ar or nitrogen is to generate an ultraviolet light which mainly excites the fluorescent material. If a partial pressure of its component is not less than 100 hPa, then a further effective suppression can be obtained to the expansion of the weak discharge gas 501 generated at the edge of the discharge cell. In case of using such discharge gas, the control by the conventional discharge mode in the selected discharge cell allows a further large width of the pulse voltage necessary for the write. In accordance with this embodiment, the increase in the width of the pulse voltage is extremely small. In case of using such discharge gas, it is possible that the discharge initiation voltage of the surface discharge is larger than the discharge initiation voltage of the opposite discharge, thereby making it difficult to control the selective discharge. In order to avoid this trouble, it is effective to reduce the thickness of the dielectric layer within and in the vicinity of the discharge gap area of the surface discharge. This structure allows setting the discharge initiation voltage of the surface discharge at an appropriate value for controlling the discharge mode in accordance with this embodiment.

### TENTH EMBODIMENT

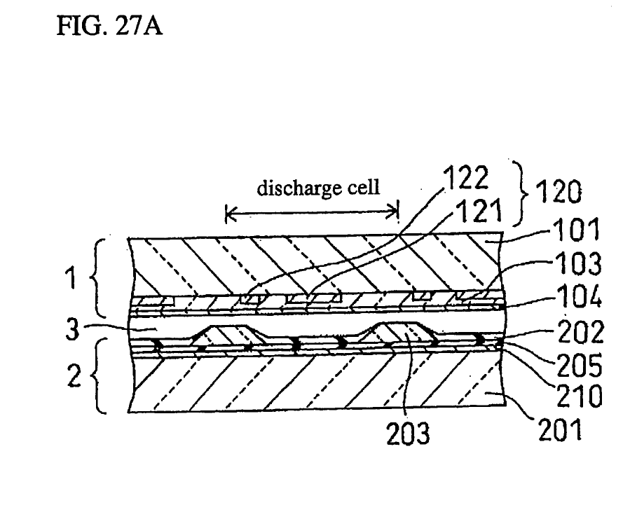

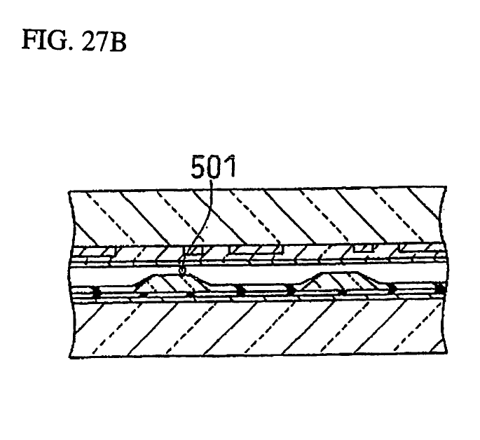

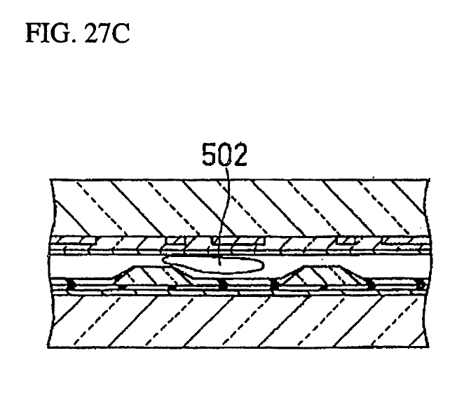

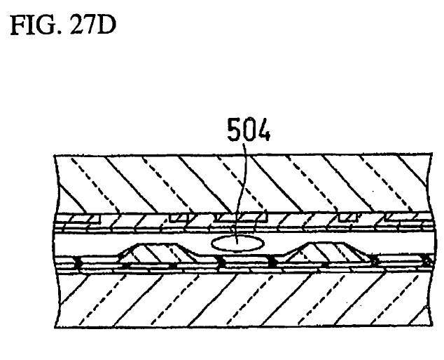

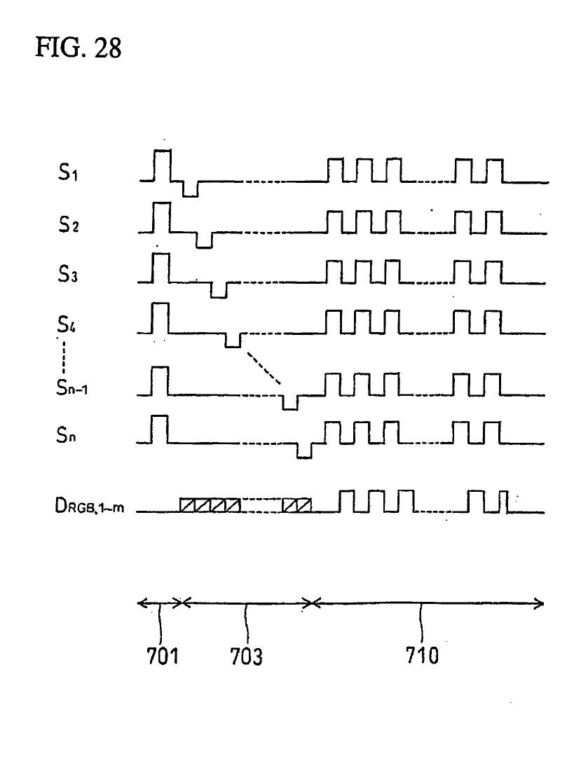

A tenth embodiment of the present invention will be described. The tenth embodiment provides a plasma display panel realizing a display discharge by an opposite discharge. FIG. 27A is a fragmentary cross sectional view showing a discharge cell in a non-discharge state of the plasma display panel in accordance with the tenth embodiment of the present invention. FIG. 27B is a fragmentary cross sectional view showing a discharge cell in a weak initial discharge state of the plasma display panel in accordance with the tenth embodiment of the present invention. FIG. 27C is a fragmentary cross sectional view showing a discharge cell in a transitional discharge state of the plasma display panel in accordance with the tenth embodiment of the present invention. FIG. 27D is a fragmentary cross sectional view showing a discharge cell in a display discharge state of the plasma display panel in accordance with the tenth embodiment of the present invention. FIG. 28 is a timing chart showing a method of driving the plasma display panel in accordance with the tenth embodiment of the present invention.

In accordance with the tenth embodiment, as shown in FIG. 27A, only opposite discharge scanning electrodes 120 are provided as electrodes over the front substrate 1. The opposite discharge scanning electrode 120 comprises a display discharge electrode part 121 arranged at a center of the discharge cell and a weak discharge electrode part 122 facing to one of the stepped portions 203.

In accordance with the tenth embodiment, similarly to a three-electrode surface discharge plasma display, in the selective discharge time period, as shown in FIG. 27A, no discharge is generated in the non-selected discharge cell, while as shown in FIG. 27B, the weak discharge 501 is generated between the weak discharge electrode part 122 and the data electrode 210 in the selected discharge cell. Subsequently, in the selected discharge cell, the weak discharge 501 expends and is transitioned to the discharge 502 as shown in FIG. 27C. As a result, the wall charges are generated on surfaces of the front substrate and the back substrate. In the subsequent display discharge time period, as shown in FIG. 27D, an opposite display discharge 504 is generated between the display discharge electrode part 121 and the data electrode 210.

In accordance with the tenth embodiment, it is possible to improve the high speed performance and reduce the necessary voltage. In the non-selected discharge cell, the selective discharge may be controlled to generate the weak discharge 501 at the discharge space over the stepped portions 203 to further improve the high speed performance and further reduce the necessary voltage.

### ELEVENTH EMBODIMENT

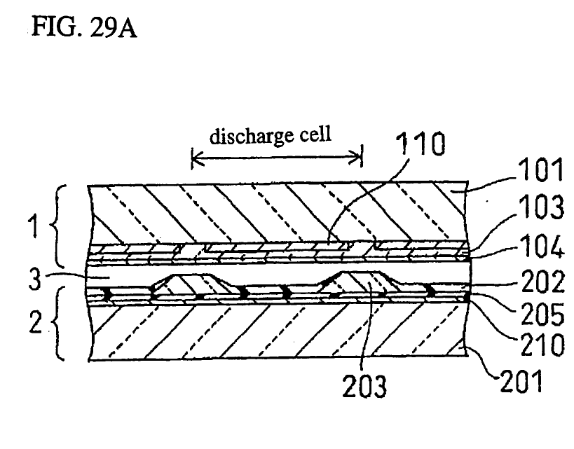

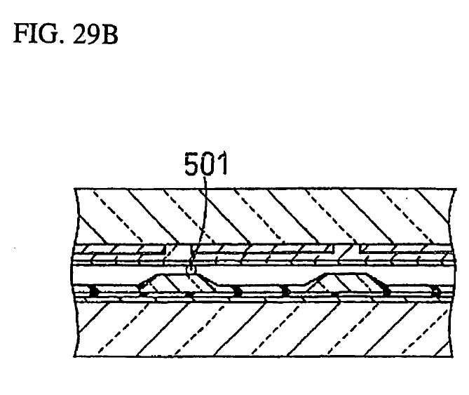

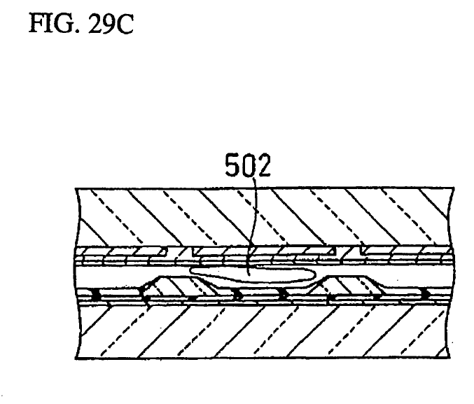

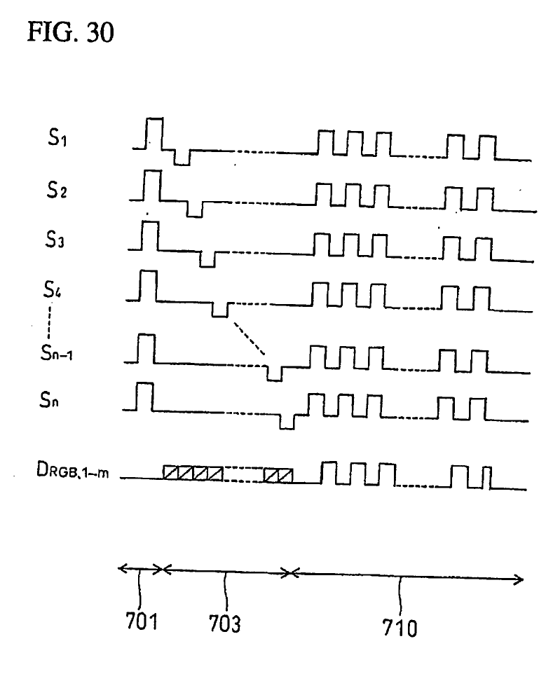

An eleventh embodiment of the present invention will be described. The eleventh embodiment provides a plasma display panel realizing a display discharge by an opposite discharge. FIG. 29A is a fragmentary cross sectional view showing a discharge cell in a non-discharge state of the plasma display panel in accordance with the eleventh embodiment of the present invention. FIG. 29B is a fragmentary cross sectional view showing a discharge cell in a weak initial discharge state of the plasma display panel in accordance with the eleventh embodiment of the present invention. FIG. 29C is a fragmentary cross sectional view showing a discharge cell in a transitional discharge state of the plasma display panel in accordance with the eleventh embodiment of the present invention. FIG. 29D is a fragmentary cross sectional view showing a discharge cell in a display discharge state of the plasma display panel in accordance with the eleventh embodiment of the present invention. FIG. 30 is a timing chart showing a method of driving the plasma display panel in accordance with the eleventh embodiment of the present invention.

In accordance with the eleventh embodiment, as shown in FIG. 29A, the opposite discharge scanning electrodes 110 comprises a single transparent electrode. In accordance with the eleventh embodiment, in the selective discharge time period, as shown in FIG. 29A, no discharge is generated in the non-selected discharge cell, while as shown in FIG. 29B, the weak discharge 501 is generated between the opposite discharge scanning electrodes 110 and the data electrode 210 in the selected discharge cell. Subsequently, in the selected discharge cell, the weak discharge 501 expends and is transitioned to the discharge 502 as shown in FIG. 29C. As a result, the wall charges are generated on surfaces of the front substrate and the back substrate. In the subsequent display discharge time period, an opposite display discharge is generated between the opposite discharge scanning electrodes 110 and the data electrode 210.

In accordance with the eleventh embodiment, it is possible to improve the high speed performance and reduce the necessary voltage. In the non-selected discharge cell, the selective discharge may be controlled to generate the weak discharge 501 at the discharge space over the stepped portions 203 to further improve the high speed performance and further reduce the necessary voltage.

### TWELFTH EMBODIMENT

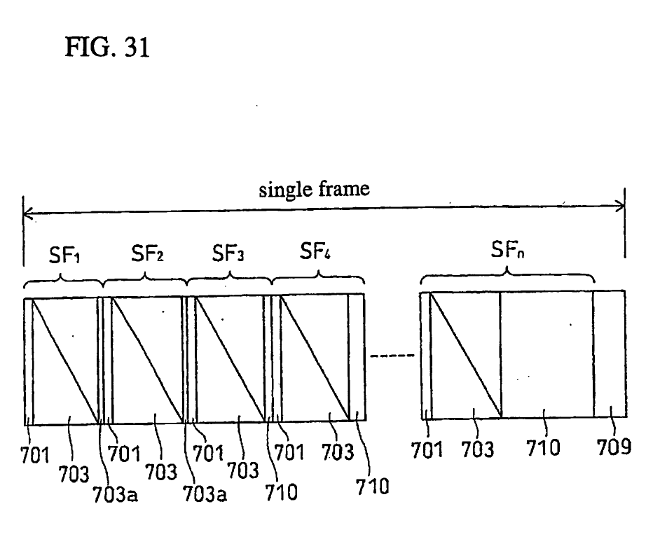

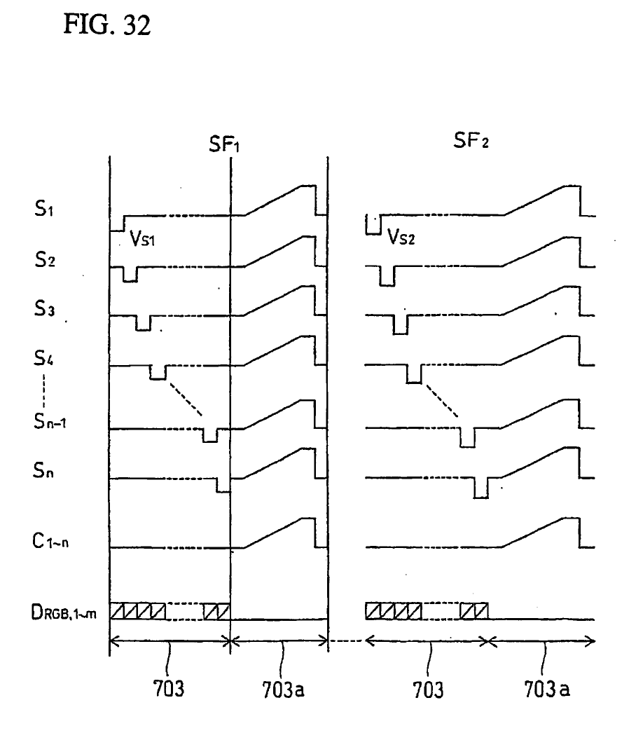

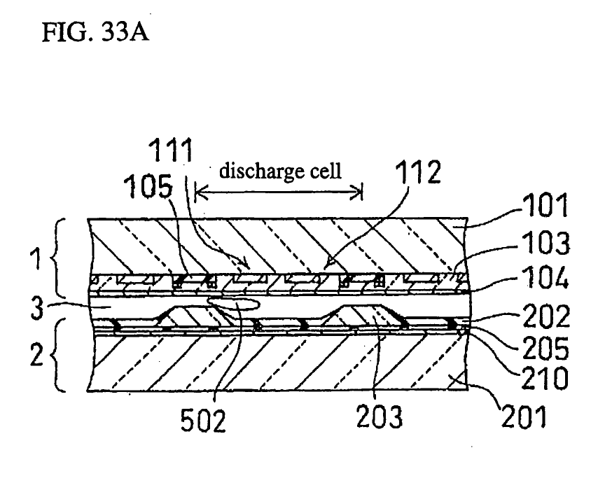

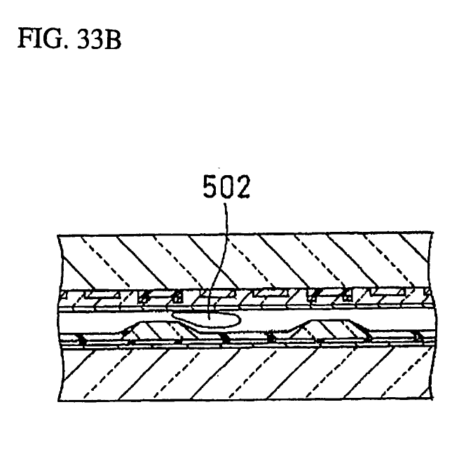

A twelfth embodiment of the present invention will be described. The twelfth embodiment corresponds to the modified embodiment to the second embodiment and is different from the second embodiment in view of a gray scale display. The twelfth embodiment provides a method of gray scale display. FIG. 31 is a schematic view showing a configuration of a single frame in accordance with the twelfth embodiment of the present invention. FIG. 32 is a timing chart showing a method of driving the plasma display panel in accordance with the twelfth embodiment of the present invention. FIG. 33A is a cross sectional view showing a discharge cell in a transitional discharge state of the plasma display panel in accordance with the twelfth embodiment of the present invention. FIG. 33B is a cross sectional view showing a discharge cell in a transitional discharge state of the plasma display panel in accordance with the twelfth embodiment of the present invention.

In accordance with this embodiment, the expansion state of the expended discharge 502 in the selective discharge cell can be controlled by varying the voltage of the scanning pulses Ps applied to the scanning electrodes 111 and the voltage of the data pulses Pd applied to the data electrodes 210. For example, as shown in FIG. 32, three kinds of the voltage are applied across the scanning electrodes 111 and the data electrodes 210. There are taken three states of the wall charges accumulated in the discharge cell in the area over the scanning electrodes 111 at the end of the selective discharge. Namely, in the selective discharge time period 703 of the first sub-field SF1, a low voltage is applied so that the expanded discharge 502 is so generated relatively as small shown in FIG. 33A. In the selective discharge time period 703 of the second sub-field SF2, a middle voltage is applied so that the expanded discharge 502 is so generated as slightly larger than that of the first sub-field SF1 as shown in FIG. 33B. In the selective discharge time period 703 of the later sub-field, a higher voltage is applied so that the expanded discharge 502 is so generated as larger than the above. In the first and second sub-fields SF1 and SF2, instead of the display discharge time period, a selective discharge erasing time period 703a is provided following to the selective discharge time period 703. In this selective discharge erasing time period 703a, an erasing pulse of saw-tooth waveform is applied to the scanning electrodes S1 to Sn and the sustaining electrodes C1 to Cn simultaneously. In the other sub-fields, the display discharge time period following to the selective discharge time period, at least one time, the sustaining discharge pulse is applied to the scanning electrodes 111 and the common electrodes 112. The first discharge is a display discharge realizing a luminescent intensity corresponding to the state of the wall charges. The state of the wall charges depends on the degree of the expansion of the discharge 502. The modulation to the brightness can be made by a single time pulse voltage for display. Accordingly, it is possible to realize a gray scale display with low brightness levels and realize a high quality of image of the plasma display. It is also possible that a blank time period 709 may be provided at the end of the single frame for time adjustment.

In the above-described embodiments, the discharge cell has a plan shape of a rectangle. The present invention can be applied to other discharge cells in plan shapes of square, other polygons such as hexagon for obtaining the same effects.

Waveforms of the applied voltages in the respective time periods for the reset discharge, the priming discharge, the selective discharge and the display discharge may be selectable with reference to the structure of the plasma display panel and the composition of the gas. It is, therefore, effective to use the sloped waveform as well as apply a series of other pulses and also apply a bias voltage to electrodes free of application of the pulses in respective time period. It is not necessary that the bias voltage is constant. The bias voltage may have a waveform of step-shape or a sloped-shape.

The stepped portions and the light shielding portions are not essential. The provision of the stepped portions make it easy to control separately discharges generated at a peripheral area except in the display discharge time period, as compared to another case of the absence of the stepped portions. The height of the stepped portions is preferably in the range of 0.2 times to 0.9 times of the distance of the substrates. If the height of the stepped portions is less than 0.2 times of the distance of the substrates so that the height is too low, then this means a small difference between the voltage necessary for the opposite discharge in an area generating the display discharge and the voltage necessary for the opposite discharge in the peripheral area except in the display discharge time period. The controllability to the discharge generated in the peripheral area except in the display discharge time period is almost the same as when no stepped portions are provided. If the height of the stepped portions exceeds 0.9 times of the distance between the substrates, then an extremely high voltage is necessary for generating the opposite discharge in the stepped area, whereby it is possible that no discharge is caused in the peripheral area except in the display discharge time period.

If the height of the stepped portions is not less than 0.6 times of the distance between the substrates, then the difference may be 10V between the voltage necessary for the opposite discharge in the area generating the display discharge and the voltage necessary for the opposite discharge in the peripheral area except in the display discharge time period. This means it easy to control those discharges separately. Particularly, this is effective if the discharge gas includes at least two components of Xe, Kr, Ar and N2 and the sum of those partial pressures is not less than 100 hPa.

It is also preferable that the width of the flat portion of the stepped portions is ranged from 0.2 times to 0.7 times of the distance between the stepped portions. If the width of the flat portion is less than 0.2, then a discharge generated in the non-discharge gap area is likely to expand to the adjacent discharge cell, thereby making it difficult to control the discharge cell but only in the discharge cell intended to have a discharge. If the width of the flat portion exceeds 0.7, then a small gap is formed between the substrates in the peripheral area of the surface discharge gap area, whereby an increased voltage is necessary for initiating the surface discharge for increasing the driving voltage.

If the width of the stepped portions is not less than 0.5 times of the distance between the stepped portions, then the difference may be 10V between the voltage necessary for the opposite discharge in the area generating the display discharge and the voltage necessary for the opposite discharge in the peripheral area except in the display discharge time period. This means it easy to control those discharges separately. Particularly, this is effective if the discharge gas includes at least two components of Xe, Kr, Ar and N2 and the sum of those partial pressures is not less than 100 hPa.

The flat portion of the stepped portion is generally parallel to the surface of the back substrate. If is possible to provide, on the flat portion, any part such as the separating wall 223 as shown in FIG. 26 which is in contact with the front substrate.

In case of providing the light shielding layers, it is possible to obtain a high contrast with high quality display without increasing the black brightness even if the luminescence is caused by the weak discharge in the peripheral area of the light shielding layers in the non-selected state.

The components of the discharge gas should not particularly be limited. It is preferable that the discharge gas filled in the discharge cell contains at least one of e, Kr, and Ar or further contains N2, and the sum of those partial pressures is not less than 100 hPa. The discharge cell having those discharge gas not only shows the high luminescent efficiency but also suppresses the expansion of the discharge, thereby making it easy to generate a localized discharge. The use of the Ar-containing discharge gas is likely to cause the discharge to be limited within a narrow area. The use of the N2-containing discharge gas generates a near ultraviolet ray to be used effectively, thereby obtaining a high luminescent efficiency. If the discharge gas contains N2 but free of Xe, Kr, and Ar, then a remarkably increased discharge is necessary. The use of the discharge gas containing at least one of Xe, Kr, and Ar suppresses any increase of the necessary discharge voltage. The components of those rear gases suppress the expansion of the discharge.

The present inventor manufactured the plasma display panels in accordance with the foregoing embodiments. A manufacturing method thereof and its results and effects will be described.

Descriptions will be made of a method of manufacturing the plasma display panel shown in FIG. 9 in accordance with the present invention. A unit discharge cell was designed to have a length of 1.08 millimeters in a direction perpendicular to the surface discharge electrode. A non-conductive light shielding layer 105 was formed on the first glass substrate 101, wherein the non-conductive light shielding layer 105 contains an inorganic black pigment for shielding the inside light reflection and the unnecessary luminescence from the discharge space 3 of the plasma display. Transparent electrode portions 111a and 111b were formed which comprise an indium oxide based transparent conductive thin film (indium tin oxide). The width of the transparent electrode portions was ranged from 150 micrometers to 350 micrometers. Low resistive wirings 111b and 112b were formed at peripheries of the discharge cells outside the transparent electrodes, wherein the low resistive wirings 111b and 112b extend in parallel to the transparent electrodes. The low resistive wirings 111b and 112b contain Ag fine particles as a main component. The transparent electrodes are connected to the low resistive wirings through connections so that the transparent electrodes have the same potential as the low resistive wirings.

The connections may comprise a low resistive wiring material, a transparent conductive thin film material or alternating laminations thereof as shown in FIGS. 15A, 15B, 15C and 15D. It is preferable that the connection is formed at a position corresponding to the separating wall 220. Unless remarkably disturbing transmission of the visible light from the discharge cell to the display screen, then the connection may be formed in the discharge cell. For example, if a low resistive wiring material having a width of not more than 20 micrometers is provided at the center of the discharge cell, then the luminescent property such as the luminescent efficiency is almost the same as in the case of providing the connection at a position corresponding to the separating wall. If the connection is provided at the position corresponding to the separating wall, then it is not necessary to provide the connections at the positions corresponding to all of the separating walls, and it is also possible to form the connections for every one or every two or more of the separating walls.

The width of the low resistive wiring was ranged from 30-80 micrometers. A width of the opening of the surface discharge electrode between the transparent electrode portion and the low resistive wiring is ranged from 100-250 micrometers. A distance between the low resistive wirings over the discharge cells or the non-discharge gap is ranged from 60-160 micrometers. The low resistive wiring is commonly used by the adjacent surface discharge electrodes in both sides of the discharge cell as the scanning electrode or the common electrode, then the same effect can be obtained. In this case, the non-discharge gap is unnecessary, thereby increasing the flexibility in design of the surface discharge electrode.

After the surface discharge electrode 110 was formed, then a transparent dielectric layer 103 was formed to have a thickness in the range of 20 micrometers to 60 micrometers, wherein the transparent dielectric layer 103 has a low melting point glass as a main component. A flit glass as a sealant was applied by a dispenser to peripheral four sides of the display area. A protection film 104 of magnesium oxide was formed over the dielectric layer by a vacuum evaporation method, wherein the protection film 104 has a thickness in the range of 0.5 micrometers to 2 micrometers, thereby forming a front substrate 1. This front substrate 1 may be referred to as a display side substrate.

Stripe shaped data electrodes 210 were formed over a second glass substrate 201, wherein the data electrodes 210 contain Ag fine particles as a main component, and the data electrodes 210 have a thickness in the range of 80 micrometers to 150 micrometers, and the data electrodes 210 extend in a direction perpendicular to the scanning electrodes 111, and the data electrodes 210 are aligned at a distance of one third of a distance of the unit discharge cells over the above-described front substrate. A white dielectric layer 205 was formed on an area corresponding to at least the entirety of the display area, wherein the white dielectric layer 205 comprises a low melting point glass material containing an inorganic white pigment such as titanium oxide, which becomes white with high reflectivity through burning, and the white dielectric layer 205 has a thickness of 5 micrometers to 20 micrometers. It is also possible that the shape of the data electrode 210 has an increased width on an area where a weak discharge is generated in the selective discharge time period.

Separating walls 220 and stepped portions 203 were formed between respective data electrodes 210, wherein the separating walls 220 have a height which corresponds generally to the distance between the discharge space 3 and the stepped portions 203 have a height lower than the height of the separating walls 220. The separating walls 220 and stepped portions 203 comprise a low melting point glass and an inorganic filler as main components. The separating walls 220 and stepped portions 203 were formed as follows. A #-shaped structure having a height of the stepped portions 203 was formed by a sandblast method, an additive method or a screen printing method. A stripe shaped structure was stacked over the #-shaped structure in the same manner, wherein the stripe shaped structure has a height which corresponds to a subtraction of the height of the #-shaped structure from the distance between the substrates. Eleven kinds of samples were prepared, wherein the height of the separating walls is ranged from 80 micrometers to 250 micrometers, and the height of the stepped portions are varied by 0.1 pitch from 0 to 1 time of the height of the separating wall.

A red fluorescent layer (Eu-activated boron oxide), a green fluorescent layer (Mn-activated Zn silicate), a blue fluorescent layer (Eu-activated BaMg aluminate) were formed on areas defined by the separating walls 220 and the stepped portions 203 through a screen printing method or a dispense method using pastes of those row materials and subsequent burning process. For a uniform write property of the discharge cells arranged with R(Red), G(Green) and B(Blue) fluorescent materials, it is preferable that the fluorescent layer is not present over the stepped portion. Notwithstanding, it is possible that the fluorescent layer is present over the stepped portion.

At least one hole was formed in the outside of the display area, so that a glass tube for exhausting and introducing a gas is formed on an opposite side to the fluorescent formation side, wherein the glass tube is positioned corresponding to the hole for connection between the inside of the discharge cell and the outside, whereby a back substrate was completed.

The front substrate 1 and the back substrate 2 were combined to each other to have a discharge space 3 of a distance almost corresponding to the separating walls 220, wherein the surface discharge electrodes 110 extend perpendicular to the data electrodes 210. The inside of the discharge space was heated at about 370° C. with conducting an evacuation before ti was cooled to room temperature, and then a discharge gas comprising NeXe mixture gas containing 5 percents by volume of Xe was introduced into the discharge space 3, and then the glass tube for exhausting and introducing the gas was sealed, thereby forming a plasma display panel with a matrix alignment of the discharge cells. A partial pressure of the mixture gas was 700 hPa.

A driving voltage of a waveform shown in the timing chart of FIG. 10 was applied to the plasma display panel. In the reset discharge time period, a reset discharge pulse Pr serving also as a priming discharge pulse of not less than 350V was applied. At a falling edge of the reset discharge pulse Pr, a discharge for erasing wall charges was generated in all discharge cells. The scanning pulse voltage and the state pulse voltage were controlled so that application of the scanning pulse Ps only does not cause any opposite discharge, while additional application of the data pulse Pd to the scanning pulse Ps causes the opposite discharge. If the height of the stepped portions 203 is 0.5 times of the distance of the substrates (the height of the discharge space), then the weak discharge at the discharge cell periphery expends to the entirety of the scanning electrodes thereby forming a write discharge, provided the sum of the scanning pulse voltage and the data pulse voltage is approximately 200V. If the height of the stepped portions 203 is larger than 0.6 times thereof, then the weak discharge at the discharge cell periphery expends to the entirety of the scanning electrodes thereby forming a write discharge at a lower voltage. If the stepped portions 203 are absent or the height of the stepped portions 203 is less than 0.2 times thereof, then at least about 220V is necessary, and the discharge was easily expanded to the adjacent cell, whereby an erroneous discharge (erroneous write) was caused in the non-selected adjacent cell. If the height of the stepped portions 203 is increased exceeding 0.9 times of the distance of the substrates, then the voltage necessary for generating the write discharge is increased as compared the cases in the absence of stepped portions or in the presence of the low stepped portions.

The scanning voltage was set at 150V and the data voltage was set at 50V. The discharge mode in the selective discharge time period was observed. No discharge was generated in the non-selected discharge cell applied with only the scanning voltage. In the selected discharge cell applied with both the scanning voltage and the data voltage, a weak discharge was generated in the vicinity of the stepped portions before the discharge expends to a crossing area between the scanning electrode and the data electrode. Namely, the result corresponds to the first embodiment. Since the low voltage is necessary for generating the opposite discharge between the scanning electrode and the data electrode in the area of the stepped portion, then it is possible to suppress the voltage necessary for write and further reduce the scanning voltage and/or the data voltage as well as shorten the discharge delay time, thereby shortening the scanning pulse width and shortening the selective discharge time period.

The scanning voltage was set at 170V and the data voltage was set at 30V. Application of the scanning voltage causes a weak discharge in the vicinity of the stepped portion of the non-selected discharge cell. The result corresponds to the second embodiment. In the selected discharge cell, the weak discharge was generated in the vicinity of the stepped portion, and then the discharge expends to the crossing area of the scanning electrode and the data electrode, similarly to the case when the scanning voltage was set at 150V and the data voltage was set at 50V. The discharge delay time is largely shortened as compared to the above-described example corresponding to the first embodiment.

The scanning voltage was set at 170V and the data voltage was set at 30V. An evaluation was made on an example, wherein the priming discharge time period was eliminated. As a result, in the absence of the priming discharge time period or the priming discharge in the reset time period, the weak discharge generated in the non-selected state in the selective discharge time period in each sub-field serves as a priming discharge, whereby improving the high speed performance and reducing the necessary voltage.

As comparison, a plasma display panel free of the black light shielding portion 105 was prepared to measure the black brightness. If the voltage according to the second embodiment was applied, then in the non-selected discharge cell, the weak discharge is generated in every sub-fields. Notwithstanding, the panel with the black light shielding layer has a lower black brightness of at most one half of that of the panel free of the black light shielding layer.

The discharge cell distance is not limited to 1.08 millimeters. In the plasma display panel with a reduced discharge cell distance of 0.3 millimeters obtains the same effects.

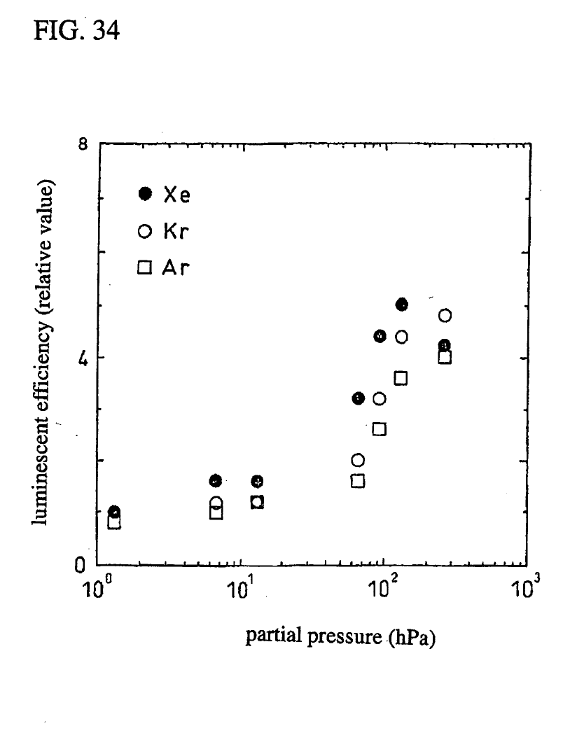

FIG. 34 is a view showing values of luminescent efficiencies under partial pressures of Xe, Kr and Ar. An horizontal axis represents respective partial pressures of Xe, Kr, and Ar. A vertical axis represents a relative value of the luminescent efficiency. A discharge gas containing Ne and Xe, Kr or Ar and having 700 hPa was introduced into the plasma display panel as manufactured, wherein partial pressures of Xe, Kr, and Ar are varied. The luminescent efficiency is a relative value, wherein if the partial pressure of Xe is 1.3 hPa, then the luminescent efficiency is 1.

As shown in FIG. 34, for every components, large improvements in the luminescent efficiency were obtained at partial pressure of at least about 100 hPa. In case of the presence of the stepped portion, localization of the weak discharge to the periphery of the discharge cell can be obtained at least about 100 hPa for subsequent expansion of the discharge for write operation. In case of the absence of the stepped portion, localization of the weak discharge to the periphery of the discharge cell is difficult and further the opposite discharge voltage is high.

### INDUSTRIAL APPLICABILITY

As described above, in accordance with the present invention, a high speed performance and a reduction of the necessary voltage can be obtained for the selective discharge for switching the discharge cell. For adjustment to the luminescent intensity of the selective discharge, the brightness in the block display can be suppressed and the adjustment to the minimum brightness can be made. It is possible to improve the quality of image with suppressing the cost. The use of the discharge gas containing Xe, Kr, Ar or N2 at partial pressure of at least 100 hPa causes a remarkable increase in the luminescent efficiency. In the prior art, the use of such discharge gas causes the increase in the driving voltage and priming particles generated by the priming discharge are quickly disappeared, resulting in an increased delay of the discharge and in an increased time necessary for the selective discharge. In accordance with the present invention, it is possible to further shorten the necessary for the selective discharge with suppressing any increase of the driving voltage, whereby there can be made the improvement in the high speed performance and reduction in the necessary voltage of the selective discharge as well as the realization of the high luminescent efficiency important for the reduction of the power comsumption.

1. A plasma display panel including:
first and second substrates arranged facing to each other;
a plurality of first electrodes provided on a surface of said first substrate, facing to said second substrate, and said plurality of first electrodes extending in a first direction;
a plurality of second electrodes provided on a surface of said second substrate, facing to said first substrate, and said plurality of second electrodes extending in a second direction perpendicular to said first direction;
a control circuit for controlling voltages applied to said first and second electrodes, based on an image signal; and
discharge cells arranged at crossing points of said plurality of first electrodes and said plurality of second electrodes, and said discharge cells generating lights, which are irradiated to fluorescence layers provided in said discharge cells and then are converted into visible lights for image display,
wherein said control circuit controls said voltages applied to said first and second electrodes so that, with scanning said first electrodes, a local discharge is generated between said first and second electrodes in a discharge cell to be selected based on said image signal, then an expansion of said local discharge is caused in said discharge cell, and subsequently a continuation of said expanded discharge is caused in only a discharge cell having said expanded discharge but after scanning said first electrodes.

2. The plasma display panel as claimed in claim 1, wherein said control circuit controls said voltages so that not only in said discharge cell selected based on said image signal but also in another discharge cell not selected based on said image signal, a local discharge is generated between said first and second electrodes, then an expansion of said local discharge is caused in said discharge cell, and subsequently a continuation of said expanded discharge is caused in only a discharge cell having said expanded discharge but after scanning said first electrodes.

3. The plasma display panel as claimed in claim 1, further including a light-shielding part which shields a visible light to an exterior from an area where said local discharge is caused.

4. The plasma display panel as claimed in claim 1, wherein said light-shielding part has a black-color-band layer which extends over at least adjacent discharge cells in the second direction.

5. The plasma display panel as claimed in claim 1, wherein said first electrode has a main electrode part and a sub-electrode part arranged closer to an edge of the discharge cell than said main electrode part, and said control circuit -controls said voltages so that said local discharge is caused between said sub-electrode part and said second electrode.

6. The plasma display panel as claimed in claim 1, wherein said first and second substrates has a distance at least at a position of one edge of said discharge cell in said second direction, and said distance is smaller than a distance between said first and second substrates at a center position of said discharge cell, and said control circuit controls said voltages so that said local discharge is caused at said position of one edge, and then said expansion of said local discharge to said center position is caused.

7. The plasma display panel as claimed in claim 1, wherein a discharge space between said first and second substrates is filled with a discharge gas containing at least one component selected from the group consisting of Xe, Kr, Ar and N2, and a total sum of partial pressures of Xe, Kr, Ar and N2 in said discharge gas is not lower than 100 hPa.

8. The plasma display panel as claimed in claim 1, wherein said first electrode has a scanning electrode and a common electrode which are separated from each other within the single discharge cell, and said control circuit provides a potential difference between said scanning electrode and said common electrode for causing a continuation of said discharge after scanning said first electrodes.

9. The plasma display panel as claimed in claim 1, wherein said first electrode has a scanning electrode and a common electrode which are separated from each other within the single discharge cell, and said scanning electrode has a main scanning electrode part and a sub-scanning electrode part arranged closer to an edge of the discharge cell than said main scanning electrode part, and said control circuit controls said voltages so that said local discharge is caused between said sub-scanning electrode part and said second electrode.

10. The plasma display panel as claimed in claim 1, further including a transparent dielectric layer covering said first electrode, wherein said first electrode has a scanning electrode and a common electrode which are separated from each other within the single discharge cell, and said dielectric layer has a smaller thickness, in a discharge gap region between said scanning electrode and said common electrode, than other part of said dielectric layer.

11. A plasma display panel including:
first and second substrates arranged facing to each other;
a plurality of first electrodes provided on a surface of said first substrate, facing to said second substrate, and said plurality of first electrodes extending in a first direction;
a plurality of second electrodes provided on a surface of said second substrate, facing to said first substrate, and said plurality of second electrodes extending in a second direction perpendicular to said first direction;
a control circuit for controlling voltages applied to said first and second electrodes, based on an image signal; and
discharge cells arranged at crossing points of said plurality of first electrodes and said plurality of second electrodes, and said discharge cells generating lights, which are irradiated to fluorescence layers provided in said discharge cells and then are converted into visible lights which represent luminescent intensities of selective discharges of said discharge cells,
wherein said control circuit controls said voltages applied to said first and second electrodes so that, with scanning said first electrodes, a local discharge is generated between said first and second electrodes in a discharge cell to be selected based on said image signal, then an expansion of said local discharge is caused in said discharge cell.

12. The plasma display panel as claimed in claim 11, wherein said control circuit controls said voltages so that not only in said discharge cell selected based on said image signal but also in another discharge cell not selected based on said image signal, a local discharge is generated between said first and second electrodes, then an expansion of said local discharge is caused in said discharge cell, and subsequently a continuation of said expanded discharge is caused in only a discharge cell having said expanded discharge but after scanning said first electrodes.

13. The plasma display panel as claimed in claim 11, wherein said luminescent intensities of selective discharges of said discharge cells correspond to a minimum brightness except for a black display.

14. The plasma display panel as claimed in claim 11, wherein said luminescent intensities of selective discharges of said discharge cells take plural values depending upon voltages applied in selection, and said control circuit selects said voltages for modulation to luminescent brightness.

15. A plasma display panel including:
first and second substrates arranged facing to each other;
a plurality of first electrodes provided on a surface of said first substrate, facing to said second substrate, and said plurality of first electrodes extending in a first direction;
a plurality of second electrodes provided on a surface of said second substrate, facing to said first substrate, and said plurality of second electrodes extending in a second direction perpendicular to said first direction; and
discharge cells arranged at crossing points of said plurality of first electrodes and said plurality of second electrodes, and said discharge cells generating lights, which are irradiated to fluorescence layers provided in said discharge cells and then are converted into visible lights for image display,
wherein said first electrode has a main electrode part and a sub-electrode part arranged closer to an edge of the discharge cell than said main electrode part.

16. The plasma display panel as claimed in claim 15, wherein said main electrode part comprises at least one kind selected from the group consisting of line-shaped electrodes containing a transparent conductive material and metal, and said sub-electrode part comprises a material lower in electrical resistance than said transparent conductive material.

17. The plasma display panel as claimed in claim 15, further including a light-shielding layer provided over said first substrate, and said light-shielding layer extending along a boundary between discharge cells adjacent to each other with reference to a direction, in which said second electrode extends, and said light-shielding layer extending in parallel to said first electrode.

18. The plasma display panel as claimed in claim 17, wherein said light-shielding layer is narrower than a width of a planarized part of supper surfaces of a stepped portion, with reference to a direction, along which said second electrode extends.

19. A plasma display panel including:
first and second substrates arranged facing to each other;
a plurality of first electrodes provided on a surface of said first substrate, facing to said second substrate, and said plurality of first electrodes extending in a first direction;
a plurality of second electrodes provided on a surface of said second substrate, facing to said first substrate, and said plurality of second electrodes extending in a second direction perpendicular to said first direction; and
discharge cells arranged at crossing points of said plurality of first electrodes and said plurality of second electrodes, and said discharge cells generating lights, which are irradiated to fluorescence layers provided in said discharge cells and then are converted into visible lights for image display,
wherein a stepped portion is provided over said second substrate, and said stepped portion is positioned at an edge of said discharge cell with reference to a direction, in which said second electrode extends, and a height of a discharge space at a center of said discharge cell with reference to said direction, in which said second electrode extends is higher than a height of said discharge space at said edge.

20. The plasma display panel as claimed in claim 19, wherein a height of said stepped portion is in the range from 0.2 times to 0.9 times of a height of said discharge space at said center.

21. The plasma display panel as claimed in claim 20, wherein the height of said stepped portion is in the range from 0.6 times to 0.9 times of said height of said discharge space at said center.

22. The plasma display panel as claimed in claim 15, wherein upper surfaces of said stepped portion are planarized, and a width of said planarized part with reference to a direction, along which said second electrode extends, is in the range of 0.2 times to 0.7 times of a length of said discharge cell in said direction.

23. The plasma display panel as claimed in claim 22, wherein said width of said planarized part with reference to a direction, along which said second electrode extends, is in the range of 0.5 times to 0.7 times of said length of said discharge cell in said direction.

24. The plasma display panel as claimed in claim 19, wherein a width of a discharge space at a center of said discharge cell with reference to a direction, along which said second electrode extends, is wider than a width of said discharge space over said stepped portion.

25. The plasma display panel as claimed in claim 19, further including a light-shielding layer provided over said first substrate, and said light-shielding layer extending along a boundary between discharge cells adjacent to each other with reference to a direction, in which said second electrode extends, and said light-shielding layer extending in parallel to said first electrode.

26. The plasma display panel as claimed in claim 25, wherein said light-shielding layer is narrower than a width of a planarized part of supper surfaces of a stepped portion, with reference to a direction, along which said second electrode extends.

27. A plasma display panel including discharge cells filled with a discharge gas containing at least one component selected from the group consisting of Xe, Kr, and Ar, and a total sum of partial pressures of Xe, Kr, and Ar is not lower than 100 hPa.

28. The plasma display panel as claimed in claim 27, wherein said discharge gas further contains N2, and a total sum of partial pressures of Xe, Kr, Ar and N2 is not lower than 100 hPa.

29. The plasma display panel as claimed in claim 27, wherein said plasma display panel further includes:
first and second substrates arranged facing to each other;
a plurality of first electrodes provided on a surface of said first substrate, facing to said second substrate, and said plurality of first electrodes extending in a first direction;
a plurality of second electrodes provided on a surface of said second substrate, facing to said first substrate, and said plurality of second electrodes extending in a second direction perpendicular to said first direction; and
discharge cells arranged at crossing points of said plurality of first electrodes and said plurality of second electrodes, and said discharge cells generating lights, which are irradiated to fluorescence layers provided in said discharge cells and then are converted into visible lights for image display,
wherein said first electrode has a main electrode part and a sub-electrode part arranged closer to an edge of the discharge cell than said main electrode part.

30. The plasma display panel as claimed in claim 27, wherein said plasma display panel further includes:
first and second substrates arranged facing to each other;
a plurality of first electrodes provided on a surface of said first substrate, facing to said second substrate, and said plurality of first electrodes extending in a first direction;
a plurality of second electrodes provided on a surface of said second substrate, facing to said first substrate, and said plurality of second electrodes extending in a second direction perpendicular to said first direction; and
discharge cells arranged at crossing points of said plurality of first electrodes and said plurality of second electrodes, and said discharge cells generating lights, which are irradiated to fluorescence layers provided in said discharge cells and then are converted into visible lights for image display,
wherein a stepped portion is provided over said second substrate, and said stepped portion is positioned at an edge of said discharge cell with reference to a direction, in which said second electrode extends, and a height of a discharge space at a center of said discharge cell with reference to said direction, in which said second electrode extends is higher than a height of said discharge space at said edge.

31. The plasma display panel as claimed in claim 27, wherein said plasma display panel further includes:
first and second substrates arranged facing to each other;
a plurality of first electrodes provided on a surface of said first substrate, facing to said second substrate, and said plurality of first electrodes extending in a first direction;
a plurality of second electrodes provided on a surface of said second substrate, facing to said first substrate, and said plurality of second electrodes extending in a second direction perpendicular to said first direction;
discharge cells arranged at crossing points of said plurality of first electrodes and said plurality of second electrodes, and said discharge cells generating lights, which are irradiated to fluorescence layers provided in said discharge cells and then are converted into visible lights for image display; and
a light-shielding layer provided over said first substrate, and said light-shielding layer extending along a boundary between discharge cells adjacent to each other with reference to a direction, in which said second electrode extends, and said light-shielding layer extending in parallel to said first electrode.

32. A method of driving a plasma display panel including:
first and second substrates arranged facing to each other;
a plurality of first electrodes provided on a surface of said first substrate, facing to said second substrate, and said plurality of first electrodes extending in a first direction;
a plurality of second electrodes provided on a surface of said second substrate, facing to said first substrate, and said plurality of second electrodes extending in a second direction perpendicular to said first direction; and
discharge cells arranged at crossing points of said plurality of first electrodes and said plurality of second electrodes, and said discharge cells generating lights, which are irradiated to fluorescence layers provided in said discharge cells and then are converted into visible lights for image display,
wherein said method includes the steps of:
sequentially applying a scanning voltage to a selected electrode of said first electrodes for generating a selective discharge between said selected electrode and said second electrode, and also generating a local discharge between said first and second electrodes in a discharge cell to be selected based on an image signal for subsequent expansion of said local discharge in said discharge cell; and
subsequently continuing said expanded discharge in only said discharge cell having said expanded discharge.

33. The method of driving a plasma display panel as claimed in claim 32, wherein said method includes the steps of:
sequentially applying a scanning voltage to a selected electrode of said first electrodes for generating a selective discharge between said selected electrode and said second electrode, and also generating a local discharge between said first and second electrodes in a discharge cell to be selected based on an image signal as well as in a non-selected discharge cell for subsequent expansion of said local discharge in said discharge cell only; and
subsequently continuing said expanded discharge in only said discharge cell having said expanded discharge.

34. A method of driving a plasma display panel including:
first and second substrates arranged facing to each other;
a plurality of first electrodes provided on a surface of said first substrate, facing to said second substrate, and said plurality of first electrodes extending in a first direction;
a plurality of second electrodes provided on a surface of said second substrate, facing to said first substrate, and said plurality of second electrodes extending in a second direction perpendicular to said first direction; and
discharge cells arranged at-crossing points of said plurality of first electrodes and said plurality of second electrodes, and said discharge cells generating lights, which are irradiated to fluorescence layers provided in said discharge cells and then are converted into visible lights for image display,
wherein with scanning said first electrodes, a local discharge is generated between said first and second electrodes in a discharge cell to be selected based on said image signal, then an expansion of said local discharge is caused in said discharge cell.

35. The method of driving a plasma display panel as claimed in claim 34, wherein said method includes the steps of:
generating a local discharge between said first and second electrodes not only in said discharge cell selected based on said image signal but also in another discharge cell not selected based on said image signal, for subsequent expansion of said local discharge in said discharge cell only; and
subsequently continuing said expanded discharge in only said discharge cell having said expanded discharge.

36. The method of driving a plasma display panel as claimed in claim 34, wherein luminescent intensities of selective discharges of said discharge cells take plural values depending upon voltages applied in selection, and said voltages are selected for modulation to luminescent brightness.
